(19) United States
(12) Patent Application Publication
(10) Pub. No.: US 2025/0144953 A1
(43) Pub. Date: May 8, 2025

(54) HEAT-SENSITIVE RECORDING MATERIAL

(71) Applicant: Koehler Innovation & Technology GmBH, Oberkirch (DE)

(72) Inventors: Uwe BRASCH, Offenburg (DE); Timo STALLING, Appenweier (DE)

(21) Appl. No.: 18/681,318

(22) PCT Filed: Aug. 11, 2022
(86) PCT No.: PCT/EP2022/072582

§ 371 Date: Feb. 5, 2024

(30) Foreign Application Priority Data
Aug. 11, 2021 (DE) 102021120941.2
Dec. 17, 2021 (DE) 102021133751.8

(51) Int. Cl. B41M 5/46; B41M 5/42; D21H 11/14; D21H 11/20

(52) U.S. Cl. CPC B41M 5/465; B41M 5/42; D21H 11/14; D21H 11/20; B41M 2205/04; B41M 2205/38

(57) ABSTRACT

The present invention relates to a heat-sensitive recording material, wherein the color layer contains at least one removable dye, more particularly a dye that can be removed in the waste paper cycle; to a process for decoloring a heat-sensitive recording material in order to obtain a fibrous material mixture, comprising the steps of providing a mixture of the heat-sensitive recording material and at least one other paper type, more particularly at least one waste paper type, and subsequently decoloring the mixture in a deinking process in order to obtain a fibrous material mixture; to a fibrous material mixture obtained by means of said process; to a process for producing a recycled paper comprising the fibrous material mixture by compressing and dewatering the fibrous material mixture; and to a recycled paper which can be obtained by means of said process.

The invention relates to a heat-sensitive recording material, a process for decoloring a heat-sensitive recording material to obtain a fibrous material mixture, a fibrous material mixture obtainable by said process, a process for producing a recycled paper comprising said fibrous material mixture, and a recycled paper obtainable by said process.

Heat-sensitive recording materials are known in principle, wherein a fundamental distinction can be made between two different types of heat-sensitive recording materials, more particularly such materials for direct thermal printing:

Type 1: A heat-sensitive recording material in which the printed image is produced by a local, heat-induced chemical reaction in a color layer, e.g., between the color former (e.g., a leuco dye) and the color developer (e.g., bisphenol A or a phenol-free alternative). As a rule, the color layer also contains a heat-sensitive solvent that melts under the influence of heat (e.g., long-chain aliphatic alcohols, amides, esters, or carboxylic acids), such that the color reaction of color former and color developer is made possible. Furthermore, the color layer may contain heat-sensitive sensitizers.

Type 2: A heat-sensitive recording material in which the printed image is produced by a heat-sensitive top layer becoming translucent by exposure to localized heat, e.g., by means of a direct thermal printer, such that an underlying color layer becomes visible. In the prior art, this technology is described or interpreted in different ways, and such a heat-sensitive recording material is obtained using partly different compositions, porosities, and materials of the top layer, is optimized for direct thermal printing, and is explained in more detail below.

In principle, the following applies:
1. The top layer should cover the underlying color layer as well as possible. This is essentially achieved by light scattering (scattering particles) and light absorption.
2. The top layer should have the highest possible contrast to the underlying color layer in order to produce a print image that is legible to the human eye and/or a machine (scanner) (e.g., white/black, or blue/yellow).
3. The top layer should be as heat-sensitive as possible such that it becomes translucent when exposed to localized heat, more particularly by means of conventional direct thermal printers. If possible, it should be possible to use type 1 and type 2 recording materials with a conventional direct thermal printer, and the printer settings should be comparable, more particularly the print head temperature and printer speed.

The present invention relates to heat-sensitive recording materials of the type 2 described above.

US 2011/172094 A discloses a recording material that comprises the following:
a) a support having a surface impregnated with a colorant or coated with a coating containing a pigment or dye and, disposed thereon,
b) a layer comprising polymer particles including a core-shell structure and, when dry, being hollow to scatter visible light, said particles having an inner first polymer shell with a Tg of 40° C. to 130° C. and an outer second polymer shell with a Tg of −55° C. to 50° C., wherein the Tg of the outer polymer shell is lower than that of the inner polymer shell.

US 2011/251060 A describes a heat-sensitive recording material consisting of a colorant and a flexible carrier substrate, the heat-sensitive recording material further consisting of a heat-sensitive layer, wherein the heat-sensitive layer consists of a binder, a plurality of organic hollow sphere pigments and a thermal solvent, and wherein the heat-sensitive layer is disposed on the colorant. The heat-sensitive layer can be provided with a barrier layer and a protective layer.

WO 2012/145456 A1 describes a heat-sensitive recording material optimized for conventional direct thermal printing, which comprises:
a) a support in the form of a sheet-like structure containing at least one colored surface and arranged thereon,
b) a layer comprising polymer particles having a core-shell structure, wherein said particles comprise an outer first polymer shell having a calculated Tg of 40° C. to 130° C., wherein said particles, when dry, comprise at least one void, and from 1% by weight to 90% by weight, based on the weight of the polymer particles, of an opacity reducer having a melting point of 45° C. to 200° C.,
wherein the colored surface has a color density sufficient to visibly stick out from the surface of the subsequent layer dispersed thereon, wherein the opacity reducer is an aromatic oxalic acid ester, an aromatic ethylene glycol ether, 1,2-diphenyloxyethane, dibenzyl oxalate, dibenzyl terephthalate, benzylbiphenyl, benzyl 2-naphthyl ether, diphenyl sulfone, m-terphenyl, p-benzyloxybenzyl benzoate, cyclohexanedimethanol benzoate, p-toluenesulfonamide, o-toluenesulfonamide, 2,6-diisopropylnaphthalene, 4,4-diisopropylbiphenyl, erucamide, stearic acid amide, palmitic acid amide or ethylene bis-stearic acid amide.

WO 2013/152287 A1 describes a heat-sensitive recording material with a two-layer, monoaxially oriented film comprising a first layer comprising an opaque beta-nucleated propylene-based polymer and a second layer comprising a dark pigment.

US 2015/049152 A describes a heat-sensitive recording material comprising a heat-sensitive layer disposed on a colored, solid support substrate, wherein the heat-sensitive layer includes single-phase scattering polymer particles each having a center, a surface, a refractive index at the center thereof that is different from a refractive index at the surface thereof, and a continuous refractive index gradient, wherein the heat-sensitive layer further includes heat-deformable particles and a binder.

EP 2993054 A1 describes a web-like heat-sensitive recording material with at least a first layer and a second layer at least partially covering the first layer, wherein the first layer has an intensive coloring at least on the side facing the second layer and the second layer has hollow pigments which can be melted by locally limited heat treatment to form a typeface, which is characterized in that the second layer also contains one or more fatty acids and one or more heat-sensitive sensitizers in addition to the hollow pigments.

US 2017/337851 A discloses a recording material, comprising:
a release liner base stock layer,
an optional adhesive layer,
a label base stock layer,
a thermal insulation layer disposed over the label base stock layer,
an ink layer disposed over the thermal insulation layer, wherein the ink layer comprises at least one color,
a covering layer disposed over the printed ink layer, and
a top coat layer disposed over the top layer,
wherein the covering layer comprises an acrylic-based composition containing light-scattering particles that cause the covering layer to be opaque in a first state and transparent in a second state, wherein at least heat or pressure is applied from a print head that causes the top layer to transition from the first state to the second state, thereby enabling the at least one color of the ink layer to be visible through the covering layer.

WO 2019/183471 A1 discloses a recording medium comprising a substrate, wherein the substrate is involved in first scattering particles with a melting point that comprise a first solid light scattering layer, and the first light scattering layer is as close as possible to a plurality of second solid scattering particles, wherein the second solid scattering particles have a lower melting point than the first melting point of the second solid scattering particles, and wherein the first light scattering layer is porous and the second scattering particles are described upon melting of the solid, wherein the first solid scattering particles are disposed to fill the space between the recording medium.

WO 2019/219391 A1 describes a heat-sensitive recording material comprising a carrier substrate which is black or colored on at least one side and a thermoresponsive layer on the at least one black or colored side of the carrier substrate, wherein the thermoresponsive layer comprises nanoparticles of at least one cellulose ester.

WO 2021/055719 A1 describes a heat- or pressure-sensitive recording material comprising a layer of an opaque material, a color material disposed on a first side of the layer of opaque material, the layer of opaque material covering the color material, wherein the opaque material in an opaque state comprises a plurality of irregular and/or odd shaped opaque polymer particles defining voids therebetween, and having different shapes and/or different sizes, and further wherein the opaque material is configured to change from the opaque state to a transparent state upon application of sufficient temperature and/or pressure to expose the coloring material beneath the opaque material.

WO 2021/062230 A1 discloses a recording medium comprising a substrate, a first light scattering layer supported by the substrate and containing first scattering particles having a first melting point, and
a plurality of second scattering particles in proximity to the first light scattering layer, wherein the second scattering particles have a second melting point that is lower than the first melting point, wherein the first light scattering layer is porous, and the second scattering particles are disposed to fill spaces between the first scattering particles upon melting, and wherein the first scattering particles comprise perforated particles.

All these known heat-sensitive recording materials need to be improved, more particularly regarding their recyclability in the waste paper cycle, if they are also to be used as a particularly high-quality raw material for white paper grades, so-called deinking furnish.

Another aspect is that these known heat-sensitive recording materials are generally only suitable or authorized for contact with food if they do not have a negative impact on food. It was therefore a further object of the present invention to provide a heat-sensitive recording material which still is suitable or authorized for contact with food, more particularly in accordance with the specifications of the ISEGA, Forschung- und Untersuchungs-Gesellschaft mbH, Aschaffenburg (as defined in this description), and which also fulfills, for example, the strict award criteria for the use of the Blue Angel eco-label for thermal papers.

Surprisingly, these tasks were solved by a heat-sensitive recording material according to claim 1.

The removal of the dye, more particularly the removal of the dye in the waste paper cycle, is also referred to as “deinking”. A suitable removable dye, more particularly a dye that can be removed in the waste paper cycle, can therefore also be referred to as a “deinkable dye”. In principle, the term “deinking” is known to those skilled in the art as the removal of printing inks from paper. In the context of the present invention, the term “dye” always refers to a deinkable dye.

Such heat-sensitive recording materials are particularly advantageous in terms of their recyclability and therefore their cost-effectiveness. In addition, such heat-sensitive recording materials meet the requirements of the ISEGA, Forschung-und Untersuchungs-Gesellschaft mbH, Aschaffenburg (as defined in this description) and/or the award criteria for the use of the Blue Angel eco-label for thermal papers regarding their suitability for use with food.

Numerous specific details are also discussed below in order to provide a comprehensive understanding of the present subject matter. However, it is obvious to the person skilled in the art that the subject matter can also be practiced and reproduced without these specific details.

All features of one embodiment can be combined with features of another embodiment if the features of the different embodiments are not incompatible.

The terminology used in the description of the present disclosure is intended only to describe certain embodiments and should not be construed as limiting the subject matter. As used in the present description and claims, the singular forms “a”, “an” are to be understood to include the plural forms as well, unless the context clearly dictates otherwise. This also applies vice versa, i.e., the plural forms also include the singular forms. It is also understood that the term “and/or” as used herein refers to and includes all possible combinations of one or more of the associated listed elements. Moreover, it is to be understood that the terms “include”, “including”, “comprise”, and/or “comprising”, when used in the present description and claims, specify the presence of the specified features, steps, operations, elements, and/or components, but do not exclude the presence or addition of one or more other features, steps, operations, elements, components, and/or groups thereof.

In the present description and claims, the terms “include”, “comprise”, and/or “comprising” may also mean “consisting of”, i.e., the presence or addition of one or more other features, steps, operations, elements, components and/or groups is excluded.

In the present description and claims, the term “including” can therefore also mean “exclusively”.

In this description, the Bekk smoothnesses mentioned (unless otherwise defined) are determined in accordance with DIN 53107 (2016).

According to a first aspect, the present invention relates to a heat-sensitive recording material comprising
a web-like carrier material,
a color layer on one side of the web-like carrier material, and
a heat-sensitive layer on the color layer so that the color layer is at least partially covered,
wherein the heat-sensitive layer is configured in such a way that it becomes translucent when exposed to localized heat, such that the underlying color layer becomes visible, characterized in that the color layer contains at least one removable dye, more particularly at least one dye which can be removed in the waste paper cycle.

The web-like carrier material is not limited in principle. In a preferred embodiment, the web-like carrier material comprises paper, synthetic paper, and/or a plastic film. The carrier material preferably has a basis weight of 30 to 100 g/m², more particularly 40 to 80 g/m².

The web-like carrier material of the heat-sensitive recording material according to the invention comprises at least one color layer, i.e., at least one black or colored side, which is achieved by applying the color layer. The term “colored side” means that the side has a color other than white or black. In other words, the heat-sensitive recording material comprises at least one side that is colored such that it is not white. Additionally, embodiments are possible in which the at least one black or colored side has several different colors, also in combination with the color black.

Embodiments in which the web-like carrier material itself is colored are also conceivable.

In a preferred embodiment, the heat-sensitive recording material according to the invention is further characterized in that after reprocessing of the heat-sensitive recording material according to INGEDE method 11, the following scores are achieved according to the Assessment of Printed Product Recyclability, Deinkability Score (according to Issue 2, January 2017):
a) Luminosity Y maximum of 35 points,
b) Color coefficient a* in the CIELAB system maximum of 20 points,
c) Dirt specks A in the two different size classes A50 maximum of 15 points and A250 maximum of 10 points,
d) Degree of dye elimination (ink elimination) IE maximum of 10 points, and
e) Filtrate darkening ΔY maximum of 10 points,
wherein the sum of all points is in the range from 0 to 100, preferably in the range from 51 to 70, more preferably in the range from 71 to 100, and/or preferably no individual point value is negative.

Preferably, the sum of all points is in the range from 0 to 50, preferably in the range from 51 to 70, particularly preferably in the range from 71 to 100.

Preferably, no individual point value is negative.

Most particularly preferably, the sum of all points is in the range from 0 to 50, preferably in the range from 51 to 70, particularly preferably in the range from 71 to 100, and no individual point value is negative.

In a preferred embodiment, the heat-sensitive recording material according to the invention is further characterized in that the at least one dye comprises at least one pigment and/or dye. The dye may comprise inorganic or organic dyes or inorganic or organic pigments.

In a preferred embodiment, the heat-sensitive recording material according to the invention is further characterized in that the at least one dye is selected from the group comprising bleachable dyes, hydrophobic dyes, hydrophobizable dyes and/or magnetic dyes.

Such dyes are characterized by a good deinkability.

The at least one dye is preferably contained in the color layer in an amount of 2 to 50% by weight, particularly preferably 10 to 35% by weight, based on the total solids content of the color layer.

This quantity does not apply if the at least one dye comprises or is carbon black. When the at least one dye comprises or is carbon black, the carbon black is contained in the color layer in an amount of 24% by weight or less, preferably 19% by weight or less, based on the total solids content of the color layer. Preferably, carbon black is contained in the color layer in an amount of 2 to 24% by weight, preferably 2 to 19% by weight, particularly preferably 10 to 24% by weight or 10 to 19% by weight, based on the total solids content of the color layer.

In another embodiment, the carbon black is contained in the color layer in an amount of less than 2% by weight, based on the total heat-sensitive recording material.

In a preferred embodiment, the heat-sensitive recording material according to the invention is further characterized in that the at least one removable (deinkable) dye, more particularly removable in the waste paper cycle, is selected from the group comprising
carbon black pigments (in smaller amounts up to max. 24% by weight, preferably up to 19% by weight),
alternative carbon black pigments: e.g., with different particle sizes, morphologies, primary/secondary particle composition and/or surface chemistry,
organic dyes, more particularly bleachable organic dyes,
direct dyes, also known as substantive dyes,
reactive dyes,
disperse dyes (organic and water-insoluble),
pigment dyes, more particularly disperse dyes,
iron oxide, Fe₃O₄ (magnetic),
sulfur dyes (e.g., Casssulfon, Diresul Black PFT fl.),
activated carbon as a dispersion,
metal complex dyes, particularly iron-based, such as iron gall ink (iron(III) gallate), this can be produced, for example, from Fe(II)SO₄+gallic acid (or tannins); under the influence of atmospheric oxygen, Fe(III) gallate is then formed in the coating),
graphite,
mica, more particularly as a substitute for the inorganic pigment,
combinations of carbon black pigments and dark pigments, more particularly dark pigments such as iron oxides, e.g., Fe₃O₄,
bio-based or food dyes, such as sepia black, caramel coloring or based on hydrothermally treated lignin, e.g., ReForce X4500 from XILLIX GmbH, Oberkirch, Germany,
printing inks for coloring (offset, (UV) flexo inks),
charcoal/charcoal dust and/or
activated carbon/activated carbon dust.

These can be present alone or in any mixture.

Particularly preferred are substantive dyes, water flexo dyes, graphite, sulfur dyes such as casssulfon, iron gall ink, inorganic and/or organic pigment dyes and/or iron oxide (Fe₃O₄), e.g., as Bayferrox 306 or iron oxide black.

Combinations of carbon black pigments and dark pigments, more particularly dark pigments such as iron oxides, e.g., Fe₃O₄, are also preferred.

In a preferred embodiment, the heat-sensitive recording material according to the invention is further characterized in that the color layer comprises at least one binder.

As binders, water-soluble starches, starch derivatives, starch-based biolatices of the EcoSphere type, methyl cellulose, hydroxyethyl cellulose, carboxymethyl cellulose, gelatine, casein, partially or completely saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide (meth)acrylate copolymers, acrylamide-acrylate-methacrylate terpolymers, polyacrylates, poly(meth)acrylic acid esters, acrylate-butadiene copolymers, polyvinyl acetates, and/or acrylonitrile-butadiene copolymers are used preferably. These can be used alone or in any mixture.

The binder is preferably contained in the color layer in an amount of 2 to 40% by weight, particularly preferably 10 to 30% by weight, based on the total solids content of the color layer.

In other embodiments, the binder is preferably contained in the color layer in an amount of 2 to 60% by weight, particularly preferably 10 to 55% by weight, based on the total solids content of the color layer.

In a preferred embodiment, the heat-sensitive recording material according to the invention is further characterized in that the at least one deinkable dye is crosslinked with the binder.

In a preferred embodiment, the heat-sensitive recording material according to the invention is further characterized in that the at least one deinkable dye is set with the binder.

Particularly preferably, carbon black is crosslinked or set with the binder.

The color layer preferably has a basis weight of 1 to 10 g/m², more particularly 3 to 8 g/m².

The color layer preferably has a thickness of 1 to 10 μm, more particularly 2 to 8 μm.

In a preferred embodiment, the heat-sensitive recording material according to the invention is further characterized in that the heat-sensitive recording material is suitable for contact with food according to the ISEGA, Forschung- und Untersuchungs-Gesellschaft mbH, Aschaffenburg.

In order to be suitable for contact with food according to ISEGA, Forschung- und Untersuchungs-Gesellschaft mbH, Aschaffenburg, preferably at least one, more particularly all, of the following requirements should be met:
1. “Methoden zur Untersuchung von Papieren, Kartons und Pappen für Lebensmittelverpackungen”, as at 2008, in accordance with regulation no. 80.56 in the Amtlichen Sammlung von Untersuchungsverfahren (Official Collection of Examination Methods) according to § 64 of the Lebensmittel- und Futtermittelgesetzbuch (LFGB; German Food and Feed Code).
2. Migration of certain elements in accordance with DIN EN 71, Part 3 “Safety of toys, migration of certain elements”, as at August 2019.
3. Heavy metal content according to Directive 94/62/EC of the European Parliament and of the Council of Dec. 20, 1994 on packaging and packaging waste, Official Journal of the European Communities L 365/10 of Dec. 31, 1994, last amended by Directive (EU) 2018/852 of the European Parliament and of the Council of May 30, 2018, Official Journal of the European Union L 150/141 of Jun. 14, 2018.
4. Model Toxics Legislation, developed by the Source Reduction Council of CONEG of Dec. 14, 1989, last amended in December 2008.
5. Directive 2011/65/EU of the European Parliament and of the Council of Jun. 8, 2011 on the restriction of the use of certain hazardous substances in electrical and electronic equipment, Official Journal of the European Union L 174/88 of Jul. 1, 2011, last amended by Commission Directive (EU) 2019/178 of Nov. 16, 2018, Official Journal of the European Union L 33/32 of Feb. 5, 2019.
6. Regulation (EC) No 1935/2004 of the European Parliament and of the Council of Oct. 27, 2004 on materials and articles intended to come into contact with food and repealing Directives 80/590/EEC and 89/109/EEC, Official Journal of the European Union L 338/4 of Nov. 13, 2004, amended by Annex No 5.17 of Regulation (EC) No 596/2009 of Jun. 18, 2009, Official Journal of the European Union L 188 of Jul. 18, 2009, Article 3.
7. Lebensmittel-, Bedarfsgegenstände- und Futtermittelgesetzbuch (Lebensmittel-und Futtermittelgesetzbuch—LFGB) in the version published on Jun. 3, 2013 (BGBI. I p. 1426), last amended by Article 97 of the Regulation of Jun. 19, 2020 (BGBI. I p. 1328), Sections 30 and 31.
8. BfR Recommendation XXXVI. Papiere, Kartons und Pappen für den Lebensmittelkontakt, revised by 62^{nd} communication, Bundesgesundheitsblatt 14 (1971) 83, last amended by 222^{nd} communication, Bundesgesundheitsblatt 62 (2019) 1546, as at Jun. 1, 2019.

In a preferred embodiment, the heat-sensitive recording material according to the invention is further characterized in that the heat-sensitive recording material meets the award criteria for the use of the Blue Angel eco-label for thermal papers.

In another preferred embodiment, the heat-sensitive recording material according to the invention is further characterized in that the heat-sensitive recording material meets the award criteria regarding recyclability for the use of the Blue Angel eco-label thermal papers.

The determination of recyclability for the use of the Blue Angel eco-label thermal paper for heat-sensitive recording material is carried out as follows.

To produce the heat-sensitive recording materials, coating colors were applied to a base paper as a web-like carrier material to produce the respective layers, wherein the heat-sensitive layer was configured in such a way that it becomes translucent when exposed to localized heat, such that the underlying color layer becomes visible.

The heat-sensitive recording materials do not comprise any additional printing ink on the surface (unprinted heat-sensitive recording materials).

Since the removal of dyes (deinking) is a common process in the stock preparation of graphic papers or graphic cardboard, the heat-sensitive recording materials should not significantly impair this process.

The test to verify recyclability was carried out using the defibration and flotation conditions of INGEDE Method 11 (Deinkability test, as at January 2018).

The (unprinted) heat-sensitive recording materials preferably fulfill at least one, more particularly both, of the following criteria:
a) In an initial mixture consisting of 100% wood-free, uncoated copy paper with a dry toner printed on both sides and a coverage of 5% (CEN_TEST Master from EN 12281) per side, the light reflectance value after flotation after the addition of 1% heat-sensitive recording material decreases only by a maximum of 6 points and the filtrate darkening by a maximum of 3 points, compared to the floated initial mixture without heat-sensitive recording material.
b) In an initial waste paper mixture of newspapers/magazines (offset, uncoated) in a ratio of 60%/40%, the light reflectance value after flotation after the addition of 5% heat-sensitive recording material deteriorates only by a maximum of 6 points and the filtrate darkening by a maximum of 3 points, compared to the floated initial mixture without heat-sensitive recording material.

In a preferred embodiment, the heat-sensitive recording material according to the invention is further characterized in that the heat-sensitive recording material does not contain, except for unavoidable amounts, any azo dyes, more particularly no azo dyes, and particularly preferably no azo dyes which can split off one of the following aromatic amines (according to Regulation (EC) 1907/2007, Annex XVII, No. 43).

In a preferred embodiment, the heat-sensitive recording material according to the invention is further characterized in that the heat-sensitive recording material does not contain, except for unavoidable amounts, any of the following compounds:
4-aminobiphenyl (92-67-1),
benzidine (92-87-5),
4-chloro-o-toluidine (95-69-2),
2-naphthylamine (91-59-8),
o-aminoazotoluene (97-56-3),
2-amino-4-nitrotoluenel (99-55-8),
p-chloroaniline (106-47-8),
2,4-diaminoanisole (615-05-4),
4,4′-diaminodiphenylmethane (101-77-9),
3,3′-dichlorobenzidine (91-94-1),
3,3′-dimethoxybenzidine (119-90-4),
3,3′-dimethylbenzidine (119-93-7),
3,3′-dimethyl-4,4′-diaminodiphenylmethane (838-88-0),
p-cresidine (120-71-8),
4,4′-methylen-bis-(2-chloroaniline) (101-14-4),
4,4′-oxydianiline (101-80-4),
4,4′-thiodianiline (139-65-1),
o-toluidine (95-53-4),
2,4-diaminotoluene (95-80-7),
2,4,5-trimethylaniline (137-17-7),
4-aminoazobenzene (60-09-3),
o-anisidine (90-04-0),
2,4-xylidine (95-68-1), and/or
2,6-xylidine (87-62-7).

According to the invention, the heat-sensitive layer on the color layer is configured in such a way that the color layer is at least partially covered, and that it becomes translucent when exposed to localized heat, such that the underlying color layer becomes visible.

This is preferably achieved by introducing scattering particles into the heat-sensitive layer.

In a preferred embodiment, the heat-sensitive recording material is characterized in that the heat-sensitive layer comprises at least one scattering particle, more particularly a polymer particle, having a glass transition temperature of −55 to 130° C., preferably of 40 to 80° C.

In another preferred embodiment, the heat-sensitive recording material is characterized in that the heat-sensitive layer comprises at least one scattering particle, more particularly a polymer particle, having a core/shell structure, wherein the scattering particles, more particularly the polymer particles, are selected from the group consisting of (i) scattering particles, more particularly polymer particles having an outer shell with a glass transition temperature of 40° C. to 80° C. and (ii) scattering particles, more particularly polymer particles, having an inner shell with a glass transition temperature of 40° C. to 130° C. and an outer shell with a glass transition temperature of −55° C. to 50° C., the glass transition temperature of the outer shell preferably being lower than that of the inner shell.

In another preferred embodiment, the heat-sensitive recording material is characterized in that the heat-sensitive layer at least one scattering particle, more particularly a polymer particle, having a melting temperature below 250° C., preferably from 0° C. to 250° C.

In another preferred embodiment, the heat-sensitive recording material is characterized in that the heat-sensitive layer comprises at least one scattering particle, more particularly a polymer particle, with an average particle size in the range from 0.1 to 2.5 μm, preferably from 0.2 to 0.8 μm.

In another preferred embodiment, the heat-sensitive recording material is characterized in that the heat-sensitive layer comprises at least one scattering particle, more particularly a polymer particle, having a glass transition temperature of −55 to 130° C., preferably of 40 to 80° C., and having an average particle size in the range from 0.1 to 2.5 μm, preferably from 0.2 to 0.8 μm.

In another preferred embodiment, the heat-sensitive recording material is characterized in that the heat-sensitive layer comprises at least one scattering particle, more particularly a polymer particle, having a core/shell structure, wherein the scattering particles, more particularly the polymer particles, are selected from the group consisting of (i) scattering particles, more particularly polymer particles having an outer shell with a glass transition temperature of 40° C. to 80° C. and (ii) scattering particles, more particularly polymer particles, having an inner shell with a glass transition temperature of 40° C. to 130° C. and an outer shell with a glass transition temperature of −55° C. to 50° C., the glass transition temperature of the outer shell preferably being lower than that of the inner shell, and having an average particle size in the range of 0.1 to 2.5 μm, preferably from 0.2 to 0.8 μm.

In another preferred embodiment, the heat-sensitive recording material is characterized in that the heat-sensitive layer comprises at least one scattering particle, more particularly a polymer particle having a melting temperature below 250° C., preferably from 0° C. to 250° C. and having an average particle size in the range from 0.1 to 2.5 μm, preferably from 0.2 to 0.8 μm.

A glass transition temperature or a melting temperature of less than 250° C. was found to be advantageous. Above temperatures of 250° C., direct thermal printing is not possible, since the temperature-time window is outside the printer specification.

An average particle size in the range of 0.1 to 2.5 μm is advantageous, as particles of this size scatter the visible light and thus cover the color layer as much as possible.

The average particle size can be determined using a Beckman Coulter instrument (laser diffraction, Fraunhofer method).

The scattering particles, more particularly the polymer particles, are preferably crystalline, semi-crystalline and/or amorphous.

The glass transition temperatures mentioned above refer to semi-crystalline or amorphous scattering particles, more particularly polymer particles. The melting temperatures refer to crystalline scattering particles, more particularly polymer particles, or to the crystalline portion of the scattering particles, more particularly the polymer particles, respectively.

The primary property of the scattering particles, preferably the polymer particles, is light scattering in the visible range of light. The secondary property is heat sensitivity.

The polymer particles preferably comprise thermoplastic polymers.

The polymer particles preferably comprise polymers, selected from the polymerization of one or more monomers, selected from the group comprising acrylonitrile, styrene, butadiene, benzyl methacrylate, phenyl methacrylate, ethyl methacrylate, divinyl benzene, 2-hydroxyethyl methacrylate, cyclohexyl methacrylate, 2-methylstyrene, 3-methylstyrene, 4-methylstyrene, alpha-methyl styrene, beta-methyl styrene, acrylamide, methacrylamide, methacrylonitrile, hydroxypropyl methacrylate, methoxy styrene, N-acrylylglycinamide and/or N-methacrylylglycinamide and/or derivatives thereof.

In another embodiment, the polymer particles may be polymerized using a plurality of ethylenically unsaturated monomers. Examples of nonionic monoethylenically unsaturated monomers comprise styrene, vinyl toluene, ethylene, vinyl acetate, vinyl chloride, vinylidene chloride, acrylonitrile, (meth)acrylamide, various (C₁-C₂₀)alkyl- or (C₃-C₂₀)alkenyl esters of (meth)acrylic acid, including methyl acrylate (MA), methyl methacrylate (MMA), ethyl (meth)acrylate, butyl (meth)acrylate, 2-hydroxyethyl (meth)acrylate, 2-ethylhexyl (meth)acrylate, benzyl (meth)acrylate, lauryl (meth)acrylate, oleyl (meth)acrylate, palmityl (meth)acrylate and stearyl (meth)acrylate. Typically, acrylic esters such as MMA, EA, BA, and styrene are preferred monomers for polymerization and formation of the shell of the polymer particles. Difunctional vinyl monomers such as divinylbenzene, allyl methacrylate, ethylene glycol dimethacrylate, 1,3-butanediol dimethacrylate, diethylene glycol dimethacrylate, trimethylolpropane trimethacrylate and the like can also be copolymerized to form a crosslinked outer shell as described in US patent application 2003-0176535 A1.

In another embodiment, the polymer particles preferably comprise (meth)acrylonitrile copolymers, polyvinyl chloride, polyvinylidene chloride, polystyrene, styrene acrylate, styrene (meth)acrylate copolymers, polyacrylonitrile, polyacrylic acid esters or also mixtures of at least two of these.

The strength and durability of the polymer particles can be influenced by crosslinking of polymer chains.

The scattering particles, more particularly the polymer particles, can be in the form of closed polymer particles, open polymer particles and/or solid particles, each of which can be regularly or irregularly shaped.

Examples of closed hollow particles include hollow spherical polymer particles or polymer particles with a core/shell structure.

Examples of hollow spherical polymer particles or polymer particles with a core/shell structure are Ropaque HP-1055, Ropaque OP-96 and Ropaque TH-1000.

Examples of polymer particles may include, more particularly, so-called “cup-shaped” polymer particles. These particles have the same materials, as to the shell, as the closed polymer particles, more particularly the closed hollow spherical polymer particles. In contrast to the classic hollow pigments, in which an inner core of gas, usually air, is completely enclosed by a shell of organic, usually thermoplastic components, the “cup-shaped” polymer particles do not have a closed shell and only surround the inner core in the form of a bowl or cup that is as closed as possible.

Further examples of open polymer particles may include cage-like polymer particles as described in WO 2021/062230 A1.

Examples of solid particles may include polyethylene, polystyrene, and cellulose esters.

The above-mentioned scattering particles, more particularly the polymer particles, can be shaped regularly or irregularly.

In an alternative embodiment, the polymer particles are spherical solid particles, preferably shaped irregularly, and/or spherical hollow particles, both preferably in the form of droplets. These preferably include polystyrene, e.g., Plastic Pigment 756A from Trinseo LLC., and Plastic Pigment 772HS from Trinseo LLC., polyethylene, e.g., Chemipearl 10 W401 from Mitsui Chemical Inc., spherical hollow particles (HSP)/spherical hollow pigments, e.g., Ropaque TH-500EF from The Dow Chemical Co., modified polystyrene particles, e.g., Joncryl 633 from BASF Corp., 1,2-diphenoxyethane (DPE), ethylene glycol m-tolyl ether (EGTE) and/or diphenyl sulfone (DPS). These can be used alone or in any mixture. These polymer particles preferably have an average particle size of 0.2 μm, 0.3 μm, 0.4 μm, 0.45 μm, 0.75 μm, or 1.0 μm.

The scattering particles, more particularly a polymer particle, are preferably contained in the heat-sensitive layer in an amount of 20% by weight to 60% by weight, preferably 30% by weight to 50% by weight, based on the solids content of the heat-sensitive layer.

Preferably, the heat-sensitive layer comprises at least one heat-sensitive material with a melting temperature in the range from 40 to 200° C., preferably from 80 to 140° C., and/or a glass transition temperature in the range from 40 to 200° C., preferably from 80 to 140° C.

Preferably, the heat-sensitive layer comprises at least one heat-sensitive material with an average particle size of 0.2 to 4.0 μm, preferably 0.5 to 2.0 μm.

In another embodiment, the heat-sensitive layer is characterized in that it comprises or consists of scattering particles, more particularly a heat-sensitive material as scattering particles, more particularly a heat-sensitive material selected from the group of biopolymers, modified biopolymers, fats, natural waxes, semi-synthetic waxes and/or synthetic waxes, wherein semi-synthetic waxes are preferred.

Such a heat-sensitive recording material is characterized more particularly by the fact that sustainable raw materials are used.

Suitable examples of biopolymers include natural biopolymers, such as proteins, peptides, nucleic acids, a-polysaccharides, P-polysaccharides, lipids, polyhydroxyalkanoates, cutin, sulberin and/or lignin.

The use of so-called technical biopolymers, such as native polymers, bio-based polymers and degradable, petroleum-based polymers is also possible.

Examples of native polymers include regenerated fibers such as viscose and cellophane, celluloid, and thermoplastic starch.

Examples of bio-based polymers include polylactides, polyhydroxybutyrates, lignin-based thermoplastics and/or epoxy acrylates based on oils, more particularly linseed oil and palm oil.

Examples of degradable, petroleum-based polymers include polyester, polyvinyl alcohol, polybutylene adipate terephthalate, polybutylene succinate, polycaprolactone and/or polyglycolide.

These can be used alone as mixtures.

Suitable examples of modified biopolymers comprise, e.g., the esters of cellulose and/or lignin. These can be used alone or as mixtures.

Suitable examples of fats comprise, for example, fats based on saturated and/or unsaturated fatty acids, such as butyric acid, lauric acid, myristic acid, palmitic acid, stearic acid, arachidic acid, lauroleic acid, myristoleic acid, palmitoleic acid, oleic acid, linoleic acid, linolenic acid, gadoleic acid and/or arachidonic acid.

Suitable examples of natural waxes comprise, for example, carnauba wax, candelilla wax and/or montan wax.

Suitable examples of synthetic waxes comprise, for example, (hydro)carbon waxes, polyolefin waxes, HD-PE waxes, PE waxes, EVA waxes, polyester waxes, polyethylene glycol waxes, PTFE waxes, fluorine waxes, Fischer-Tropsch waxes, synthetic fatty acid esters and/or reconstituted waxes. These can be used alone or as mixtures.

Suitable examples of semi-synthetic waxes comprise, for example, stearic acid amide wax and/or palmitic acid amide wax. These can be used alone or as a mixture.

The use of waxes from the group of animal waxes, vegetable waxes, mineral waxes and/or micro waxes can also be contemplated.

The use of semi-synthetic waxes is preferred, as they offer an advantageous cost-performance ratio.

The biopolymers, the modified biopolymers, the fats, the natural waxes, the semi-synthetic waxes, and the synthetic waxes can be used alone or as mixtures.

In this embodiment, the heat-sensitive material is preferably selected from amide waxes, stearic acid amide waxes, palmitic acid amide waxes or combinations thereof.

In this embodiment, the scattering particles, more particularly the heat-sensitive material, are present in the heat-sensitive layer in an amount of 5 to 100% by weight, preferably 40 to 100% by weight and particularly preferably 40 to 95% by weight, based on the total weight of the heat-sensitive layer.

In this embodiment, the heat-sensitive recording material is preferably characterized in that the scattering particles, preferably the heat-sensitive material, have a melting temperature in the range from 30 to 250° C., preferably in the range from 40 to 200° C.

In another preferred embodiment, the heat-sensitive recording material according to the invention is characterized in that the heat-sensitive layer comprises 20 to 60% by weight, preferably 30% by weight to 50% by weight of scattering particles, more particularly polymer particles having an average particle size in the range from 0.1 to 2.5 μm, preferably from 0.2 to 0.8 μm; 10 to 80% by weight, preferably 25 to 60% by weight of a heat-sensitive material with a melting temperature in the range from 40 to 200° C. and/or a glass transition temperature in the range from 40 to 200° C.; and 1 to 30% by weight, preferably 5 to 20%, by weight of a binder.

Such a heat-sensitive recording material is characterized more particularly by its functionality, its environmental properties (sustainability) and/or its economic production (simple and cost-efficient) and more particularly by the advantageous combination of these three properties.

Additionally, the heat-sensitive material preferably contributes to the opacity (covering power) of the heat-sensitive layer, e.g., by absorbing and/or scattering light. It is assumed that the heat-sensitive material quickly melts locally when exposed to localized heat from the thermal print head of the direct thermal printer, resulting in a local “softening” of the polymer particles, and thus a local reduction in opacity (opacity reduction), such that the top layer becomes translucent and the underlying color layer becomes visible.

The heat-sensitive material can also be referred to as a sensitizing agent or thermal solvent.

Preferably, the heat-sensitive material comprises one or more fatty acids based on vegetable and/or animal oils, such as stearic acid, behenic acid or palmitic acid, one or more fatty acid amides, such as stearamide, behenamide or palmitamide, an ethylene-bis-fatty acid amide, such as N,N′-ethylene bis(stearic acid amide) or N,N′-ethylene bis(oleic acid amide), one or more fatty acid alkanolamides, more particularly hydroxymethylated fatty acid amides, such as N-(hydroxymethyl) stearamide, N-hydroxymethyl palmitamide, hydroxyethyl stearamide, one or more waxes, such as polyethylene wax, candelilla wax, carnauba wax, or montan wax, one or more carboxylic acid esters, such as dimethyl terephthalate, dibenzyl terephthalate, benzyl 4-benzyloxybenzoate, di-(4-methylbenzyl) oxalate, di-(4-chlorobenzyl) oxalate or di-(4-benzyl) oxalate, ketones, such as 4-acetyl biphenyl, one or more aromatic ethers, such as 1,2-diphenoxyethane, 1,2-di-(3-methylphenoxy)ethane, 2-benzyloxynaphthalene, 1,2-bis(phenoxymethyl)benzene, or 1,4-diethoxynaphthalene, one or more aromatic sulfones, such as diphenyl sulfone, and/or an aromatic sulfonamide, such as 2-, 3-, 4-toluenesulfonamide, benzene sulfonanilide, or N-benzyl-4-toluenesulfonamide, or one or more aromatic hydrocarbons, such as 4-benzyl biphenyl, or combinations of the above compounds. These can be used alone or in any mixture.

Stearamide is preferred as it has an advantageous cost-performance ratio.

The heat-sensitive material is preferably present in the heat-sensitive layer in an amount of about 10 to about 80% by weight, particularly preferably in an amount of about 25 to about 60% by weight, based on the total solids content of the heat-sensitive layer.

Optionally, lubricants or release agents can also be present in the heat-sensitive layer. Such lubricants or release agents are present more particularly if there is no protective layer or no further layer on the heat-sensitive layer.

These agents preferably are fatty acid metal salts, such as, e.g., zinc stearate or calcium stearate, or even behenate salts, synthetic waxes, e.g., in the form of fatty acid amides such as, e.g., stearic acid amid and behenic acid amide, fatty acid alkanolamides such as, e.g., stearic acid methylolamide, paraffin waxes of different melting points, ester waxes of different molecular weights, ethylene waxes, propylene waxes of different hardnesses and/or natural waxes, such as, e.g., carnauba wax or montan wax. These can be used alone or in any mixture.

Zinc stearate is preferred, since it has an advantageous cost-performance ratio.

The lubricant or release agent is preferably present in the heat-sensitive layer in an amount of about 1 to about 10% by weight, particularly preferably in an amount of about 3 to about 6% by weight, based on the total solids content of the heat-sensitive layer.

In another preferred embodiment, at least one binder (binding agent) is present in the heat-sensitive layer. These preferably are water-soluble starches, starch derivatives, starch-based biolatices of the EcoSphere type, methyl cellulose, hydroxyethyl cellulose, carboxymethyl cellulose, gelatine, casein, partially or completely saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide (meth)acrylate copolymers, acrylamide-acrylate-methacrylate terpolymers, polyacrylates, poly(meth)acrylic acid esters, acrylate-butadiene copolymers, polyvinyl acetates, and/or acrylonitrile-butadiene copolymers are used preferably. These can be used alone or in any mixture.

Partially saponified polyvinyl alcohols are preferred, as they have an advantageous cost-performance ratio.

The binder is preferably present in the heat-sensitive layer in an amount of 1 to 30% by weight, preferably 5 to 20% by weight, based on the total solids content of the heat-sensitive layer.

In order to achieve specific application-related performance characteristics of heat-sensitive recording materials, the binder is preferably present in crosslinked form in the heat-sensitive layer, wherein the optimum degree of crosslinking of the binder is achieved in the drying step of the coating process in the presence of a crosslinking agent (crosslinker).

The crosslinking agents may be polyvalent aldehydes such as glyoxal, dialdehyde starch, glutaraldehyde, optionally in a mixture with boron salts (borax), salts or esters of glyoxylic acid, crosslinkers based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers, etc. These can be used alone or in any mixture.

Ammonium zirconium carbonate and polyamidoamine-epichlorohydrin resins (PAE resins) are particularly preferred for reasons of food compliance.

Self-crosslinking binders, such as specially modified polyvinyl alcohols or acrylates, enable crosslinking without any crosslinking agents due to the reactive, crosslinkable groups that are already incorporated in the binder polymer.

The crosslinker is preferably present in an amount of about 0.01 to about 25.0% by weight, particularly preferably in an amount of about 0.05 to about 15.0% by weight, based on the total solids content of the color layer.

In another preferred embodiment, the heat-sensitive layer contains pigments. These pigments preferably differ from the pigments in the color layer. One of the advantages of using these is that they can fix the molten chemicals produced in the thermal printing process to their surface. Pigments can also be used to control the surface whiteness and opacity of the heat-sensitive layer and its printability with conventional printing inks.

Particularly suitable pigments are inorganic pigments, both of synthetic and natural origin, preferably clays, precipitated or natural calcium carbonates, aluminum oxides, aluminum hydroxides, silicas, precipitated and fumed silicas (e.g., Aerodisp types), diatomaceous earths, magnesium carbonates, talc, kaolin, titanium oxide, bentonite, but also organic pigments such as hollow pigments with a styrene/acrylic copolymer wall or urea/formaldehyde condensation polymers. These can be used alone or in any mixture.

Preferred are calcium carbonates, aluminum hydroxides, fumed silicas, as they enable particularly advantageous application properties of the heat-sensitive recording materials regarding their subsequent printability with commercially available printing inks.

The pigments are preferably present in the heat-sensitive layer in an amount of about 2 to about 50% by weight, particularly preferably in an amount of about 5 to about 20% by weight, based on the total solids content of the heat-sensitive layer.

The heat-sensitive layer may also contain carbon black components and/or dyes/color pigments.

To control the surface whiteness of the heat-sensitive recording material according to the invention, optical brighteners can be incorporated into the heat-sensitive color-forming layer. These are preferably stilbenes.

The heat-sensitive layer may also contain inorganic oil-absorbing white pigments.

Examples of these inorganic oil-absorbing white pigments include natural or calcined kaolin, silica, bentonite, calcium carbonate, aluminum hydroxide, more particularly boehmite, and mixtures thereof.

The inorganic oil-absorbing white pigments are preferably present in the heat-sensitive layer in an amount of about 2 to about 50% by weight, particularly preferably in an amount of about 5 to about 20% by weight, based on the total solids content of the heat-sensitive layer.

In order to improve certain coating properties, it is preferable in individual cases to add additional components, more particularly rheology additives such as, e.g., thickeners and/or surfactants, to the components of the heat-sensitive recording material according to the invention.

The additional components are preferably present in the usual quantities known to those skilled in the art.

The heat-sensitive layer preferably has a basis weight of 1 to 8 g/m², more particularly 2 to 6 g/m².

The heat-sensitive layer preferably has a thickness of 1 to 10 μm, more particularly 2 to 8 μm.

In another preferred embodiment, the heat-sensitive recording material is preferably characterized in that an insulating layer is present between the web-like carrier material and the color layer.

In an alternative embodiment, the heat-sensitive recording material is preferably characterized in that the color layer is both a color layer and an insulating layer.

Such an insulating layer, or a color layer that is both a color layer and an insulating layer, causes a reduction of heat conduction through the heat-sensitive recording material. This makes the exposure to localized heat using a direct thermal printer more efficient and enables a higher thermal printer speed. The top layer becomes translucent more quickly due to the amount of heat applied, thus improving sensitivity.

This means that less dye is required, which results in improved recyclability in the material cycle, more particularly in the waste paper cycle (easier deinkability, separation of dye and carrier material components).

The insulating layer or the color layer, which is both a color layer and an insulating layer, preferably has a Bekk smoothness of more than 50 s, particularly preferably of more than 100 s and most particularly preferably of 100 to 250 s.

The insulating layer or the color layer, which is both a color layer and an insulating layer, preferably comprises a heat-insulating material.

Preferably, the heat-sensitive recording material with an insulating layer or a color layer, which is also an insulating layer, has a lower thermal conductivity than a heat-sensitive recording material that does not comprise an insulating layer or a color layer that is also an insulating layer.

The heat-insulating material preferably comprises kaolin, particularly preferably calcined kaolin, and mixtures thereof.

The heat-insulating material may also comprise hollow sphere pigments, more particularly hollow sphere pigments comprising styrene-acrylate copolymer.

These hollow sphere pigments preferably have a glass transition temperature of 40 to 80° C. and/or an average particle size of 0.1 to 2.5 μm.

The heat-insulating material is preferably present in the insulating layer in an amount of about 20 to about 80% by weight, particularly preferably in an amount of about 30 to about 60% by weight, based on the total solids content of the insulating layer.

In a color layer, which is both a color layer and an insulating layer, the heat-insulating material is preferably present in an amount of about 30 to about 70% by weight, particularly preferably in an amount of about 30 to about 60% by weight, based on the total solids content of the color layer, which is both a color layer and an insulating layer.

In order to achieve specific application-related performance characteristics of heat-sensitive recording materials, the binder is preferably present in a crosslinked form in the insulating layer and/or color layer, wherein the optimum degree of crosslinking of the binder is achieved in the drying step of the coating process in the presence of a crosslinking agent (crosslinker).

The crosslinking agents may be polyvalent aldehydes such as glyoxal, dialdehyde starch, glutaraldehyde, optionally in a mixture with boron salts (borax), salts or esters of glyoxylic acid, crosslinkers based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers, etc. These can be used alone or in any mixture.

Ammonium zirconium carbonate and polyamidoamine-epichlorohydrin resins (PAE resins) are particularly preferred for reasons of food conformity.

Self-crosslinking binders, such as specially modified polyvinyl alcohols or acrylates, enable crosslinking without any crosslinking agents due to the reactive, crosslinkable groups that are already incorporated in the binder polymer.

The crosslinker is preferably present in an amount of about 0.01 to about 25.0% by weight, particularly preferably in an amount of about 0.05 to about 15.0% by weight, based on the total solids content of the insulating or the color layer, respectively.

The insulating layer preferably has a basis weight of 1 to 5 g/m², more particularly 2 to 4 g/m².

In another embodiment, the insulating layer preferably has a basis weight of 1 to 10 g/m², more particularly 2 to 6 g/m².

The insulating layer preferably has a thickness of 1 to 10 μm, more particularly 2 to 8 μm.

The color layer, which is both a color layer and an insulating layer, preferably has a basis weight of 1 to 10 g/m², more particularly 3 to 8 g/m².

The color layer, which is both a color layer and an insulating layer, preferably has a thickness of 1 to 12 μm, more particularly 4 to 8 μm.

In another preferred embodiment, the heat-sensitive recording material is preferably characterized in that a layer comprising starch (starch precoat) and/or modifications thereof (modified starches) is present directly on at least one side of the web-like carrier material, preferably directly on both sides of the web-like carrier material.

The starch precoat is preferably applied in an amount of 0.1 to 3, particularly preferably 0.2 to 1.5 g/m².

A starch precoat on the side of the web-like carrier material on which the color layer is present has the advantage that the web-like carrier material is sealed, thus improving the adhesion of the color layer, and reducing or preventing penetration of the color layer into the web-like carrier material.

A starch precoat on the side of the web-like carrier material on which the color layer is not present has the advantage that a penetration of the color layer through the web-like carrier material can be reduced or prevented.

The layer comprising starch preferably has a Bekk smoothness of more than 20 s, more preferably of more than 50 s and most preferably of 50 to 200 s.

In another preferred embodiment, the heat-sensitive recording material is preferably characterized in that a protective layer is present on the heat-sensitive layer.

The protective layer preferably has a Bekk smoothness of more than 200 s, preferably more than 400 s and most preferably from 400 s to 1500 s. Most preferably, the Bekk smoothness is 400 to 1300 s.

This layer is on the side of the heat-sensitive layer away from the color layer.

This protective layer preferably comprises at least one binder and at least one pigment, particularly preferably an inorganic pigment.

Suitable binders include water-soluble starches, starch derivatives, starch-based biolatices of the EcoSphere type, methylcellulose, hydroxyethyl cellulose, carboxymethyl cellulose, partially or fully saponified polyvinyl alcohols, chemically modified polyvinyl alcohols such as acetoacetyl-, diacetone-, carboxy-, silanol-modified polyvinyl alcohols, or styrene-maleic anhydride copolymers, styrene-butadiene copolymers, acrylamide-(meth)acrylate copolymers, acrylamide-acrylate-methacrylate terpolymers, polyacrylates, poly(meth)-acrylic acid esters, acrylate-butadiene copolymers, polyvinyl acetates and/or acrylonitrile-butadiene copolymers. These can be used alone or in any mixture.

Suitable inorganic pigments comprise inorganic pigments, both of synthetic and natural origin, preferably clays, precipitated or natural calcium carbonates, aluminum oxides, aluminum hydroxides, silicas, precipitated and fumed silicas (e.g., Aerodisp types), diatomaceous earths, magnesium carbonates, talc, kaolin, titanium oxide, bentonite, but also organic pigments such as hollow pigments with a styrene-acrylate copolymer wall or urea/formaldehyde condensation polymers. These can be used alone or in any mixture.

Suitable organic pigments include hollow pigments with a styrene-acrylate copolymer wall or urea/formaldehyde condensation polymers. These can be used alone or in any mixture.

The binder is preferably present in the protective layer in an amount of about 40 to about 90% by weight, particularly preferably in an amount of about 50 to about 80% by weight, based on the total solids content of the protective layer.

The pigment is preferably present in the protective layer in an amount of about 5 to about 40% by weight, particularly preferably in an amount of about 10 to about 30% by weight, based on the total solids content of the protective layer.

In order to achieve specific application-related performance characteristics of heat-sensitive recording materials, the binder is preferably present in a crosslinked form in the protective layer, wherein the optimum degree of crosslinking of the binder is achieved in the drying step of the coating process in the presence of a crosslinking agent (crosslinker).

The crosslinking agents may be polyvalent aldehydes such as glyoxal, dialdehyde starch, glutaraldehyde, optionally in a mixture with boron salts (borax), salts or esters of glyoxylic acid, crosslinkers based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers, etc. These can be used alone or in any mixture.

Ammonium zirconium carbonate and polyamidoamine-epichlorohydrin resins (PAE resins) are particularly preferred for reasons of food compliance.

Self-crosslinking binders, such as specially modified polyvinyl alcohols or acrylates, enable crosslinking without any crosslinking agents due to the reactive, crosslinkable groups that are already incorporated in the binder polymer.

The crosslinker is preferably present in an amount of about 0.01 to about 25.0, particularly preferably in an amount of about 0.05 to about 15.0% by weight, based on the total solids content of the color.

The crosslinker is preferably present in an amount of about 0.01 to about 25.0, particularly preferably in an amount of about 0.05 to about 15.0% by weight, based on the total solids content of the protective layer.

The protective layer also preferably comprises at least one lubricant or at least one release agent.

These agents preferably are fatty acid metal salts, such as, e.g., zinc stearate or calcium stearate, or even behenate salts, synthetic waxes, e.g., in the form of fatty acid amides such as, e.g., stearic acid amid and behenic acid amide, fatty acid alkanolamides such as, e.g., stearic acid methylolamide, paraffin waxes of different melting points, ester waxes of different molecular weights, ethylene waxes, propylene waxes of different hardnesses and/or natural waxes, such as, e.g., carnauba wax or montan wax.

The lubricant or release agent is preferably present in an amount of about 1 to about 30% by weight, particularly preferably in an amount of about 2 to about 20% by weight, based on the total solids content of the protective layer.

To control the surface whiteness of the heat-sensitive recording material according to the invention, optical brighteners, preferably stilbenes, can be incorporated into the protective layer.

The protective layer preferably has a basis weight of 0.3 to 5.0 g/m², more particularly 1.0 to 3.0 g/m².

The protective layer preferably has a thickness of 0.3 to 6.0 μm, more particularly 0.5 to 2.0 μm.

The use of a protective layer has the advantage that the recording material is better protected against external influences.

In another preferred embodiment, the heat-sensitive recording material is preferably characterized in that an adhesive layer is present on the web-like carrier material on the side on which the color layer is not located.

If a starch precoat is present, this is located between the web-like backing material and the adhesive layer.

The adhesive layer preferably comprises at least one adhesive, preferably a heat-activated adhesive, more particularly a pressure-sensitive adhesive.

It is particularly preferred that the adhesive, preferably the heat-activated adhesive and more particularly the pressure-sensitive adhesive, is a rubber-based and/or acrylate-based adhesive.

The adhesive layer preferably has a basis weight of 1 to 40 g/m², more particularly 12 to 25 g/m².

In another preferred embodiment, the heat-sensitive recording material is preferably characterized in that a siliconized release layer is present on the heat-sensitive layer.

The terms “siliconized release layer” and “siliconized layer” are to be understood synonymously in the sense of “covered with a layer of silicone”. Preferably, these layers consist of silicone or comprise at least 90% by weight, preferably at least 95% by weight and particularly preferably at least 99% by weight and most preferably only silicone except for unavoidable traces or additives (e.g., for UV curing of a siliconization liquid).

The siliconized release layer preferably has a Bekk smoothness of more than 400 s, particularly preferably more than 800 s and most preferably from 800 to 2000 s.

If a protective layer, more particularly as defined above, is present on the heat-sensitive layer, the siliconized release layer is preferably located on this protective layer.

In another preferred embodiment, the heat-sensitive recording material is preferably characterized in that a diffusion layer is formed between the siliconized layer and the underlying layer, preferably the heat-sensitive layer. This diffusion layer is preferably formed by diffusion of at least parts of the siliconized release layer into the upper area of the layer below, wherein preferably 5 to 50% by weight, particularly preferably 6 to 45% by weight and more particularly 7 to 40% by weight of the siliconized release layer diffuse into the upper area of the underlying layer. Such a diffusion layer is described, for example, in EP 3 221 153 A1.

A siliconized release layer is preferably present if an adhesive layer, as described above, is also present.

The presence of a siliconized release layer on the heat-sensitive layer and an adhesive layer on the web-like carrier material on the side on which the color layer is not located has the advantage that the heat-sensitive recording material can be used as a linerless heat-sensitive recording material.

Linerless means that the (self-adhesive) heat-sensitive recording material according to the invention is not applied to a carrier material, but is wound on itself. This has the advantage that the manufacturing costs can be further reduced, more running meters per roll can be realized, no disposal costs are required for the disposal of the liner and more labels can be transported per specific loading space volume.

If a siliconized release layer is present, it is preferred that at least one platelet-like pigment is contained in the heat-sensitive layer or in the layer directly below the siliconized release layer.

The at least one platelet-like pigment is preferably selected from the group consisting of kaolin, Al(OH)₃ and/or talc. The use of kaolin is particularly preferred. The use of a coating kaolin is particularly preferred. Such a product is available, for example, under the trade name Kaolin ASP 109 (BASF, Germany).

The main advantage of using these platelet-like pigments, more particularly kaolin, is that the heat-sensitive layer or the layer directly below the siliconized release layer can be siliconized very easily.

Platelet pigment is understood to be a pigment in which the ratio of diameter to thickness is about 7 to 40:1, preferably about 15 to 30:1.

The particle size of the platelet-like pigment is preferably adjusted such that at least about 70%, preferably at least about 85%, of the particles have a particle size of about <2 μm (sedigraph). The pH value of the platelet-like pigment in aqueous solution preferably is 6 to 8.

The at least one platelet-shaped pigment is present in the heat-sensitive color-forming layer or in the layer lying directly below the siliconized release layer, preferably in an amount of about 5 to about 60% by weight, particularly preferably in an amount of about 15 to about 55% by weight, based on the total solids content of the respective layer.

In another preferred embodiment, the heat-sensitive recording material is preferably characterized in that the siliconized release layer comprises at least one siloxane, preferably a poly(organo)siloxane, more particularly an acrylic poly(organo)siloxane.

In another embodiment, the siliconized release layer comprises a mixture of at least two siloxanes. A mixture of at least two acrylic poly(organo)siloxanes is preferred.

Examples of particularly preferred siloxanes are siloxanes available under the trade names TEGO®RC902 and TEGO®RC711 (Evonik, Germany).

In another embodiment, the heat-sensitive recording material is preferably characterized in that the siliconized release layer comprises at least one polysilicone acrylate, preferably formed by condensation of at least one silicone acrylate.

The siliconized release layer is preferably anhydrous. It is also preferred that the siliconized release layer does not contain any Pt catalysts.

The siliconized release layer preferably contains an initiator, particularly preferably a photoinitiator. This is used for radical curing of the silicone.

The TEGO® photoinitiator A18 (from Evonik, Germany) is particularly preferred.

The siliconized release layer can preferably contain further additives, such as matting agents and/or adhesion additives.

The siliconized release layer preferably has a basis weight of 0.1 to 5% by weight or 0.3 to 5.0 g/m², more particularly 1.0 to 3.0 g/m², or preferably 0.2 to 2.0% by weight.

The siliconized release layer preferably has a thickness of 0.3 to 6.0 μm, more particularly 0.5 to 2.0 μm.

Due to its hydrophobic character, the application of a siliconized release layer generally leads to improved resistance of the heat-sensitive recording material to hydrophilic agents such as alcohols or water. The siliconized release layer is therefore also suitable as a protective layer.

In another preferred embodiment, the heat-sensitive recording material is preferably characterized in that the heat-sensitive recording material has a residual moisture content of 2 to 14%, preferably of 2 to 12% and most preferably of 3 to 10%. A residual moisture content of 3 to 8% is most preferable.

The residual moisture can be determined as described in connection with the examples.

It is assumed that the opacity in the heat-sensitive layer is generated not only by the scattering particles, more particularly the polymer particles, themselves, but also by the air trapped between the scattering particles, more particularly the polymer particles (open porosity). The penetration of moisture into these “pores” will displace air and reduce opacity. This can result in a grayer material, which is not preferred.

In another preferred embodiment, the heat-sensitive recording material is preferably characterized in that the heat-sensitive recording material has a surface whiteness of 35 to 60%, more particularly of 45 to 50%.

A residual moisture content in the specified ranges has the advantage that after printing there is a high relative print contrast with advantageous application properties, such as better legibility.

The surface whiteness (paper whiteness) can be determined in accordance with ISO 2470-2 (2008) using an Elrepho 3000 spectrophotometer.

In another preferred embodiment, the heat-sensitive recording material is preferably characterized in that the contrast between locations where the heat-sensitive layer has become translucent due to exposure to localized heat, and locations where the heat-sensitive layer has not become translucent due to exposure to localized heat is 40 to 80%, more particularly from 50 to 70%.

This contrast can be calculated by taking the difference between the optical density of the background and the typeface. The optical density (O.D.) is measured using a densitometer, for example.

All of the above layers can be single- or multi-layered.

Preferably, the carrier material has a Bekk smoothness of more than 20 s, particularly preferably more than 30 s and most particularly preferably more than 50 s on the side to which the color layer is applied.

The color layer preferably has a Bekk smoothness of more than 50 s, particularly preferably more than 100 s and most particularly preferably more than 150 s on the side to which the heat-sensitive layer is applied.

The heat-sensitive layer preferably has a Bekk smoothness of more than 100 s, particularly preferably more than 150 s, on the side on which the color layer is not located.

Preferably, the carrier material has a Bekk smoothness of 20 to 400 s, particularly preferably of 30 to 300 s and most particularly preferably of 50 to 200 s on the side to which the color layer is applied. Most preferably, the Bekk smoothness is 50 to 150 s.

The color layer preferably has a Bekk smoothness of 50 to 400 s, particularly preferably of 100 to 250 s and most particularly preferably of 150 to 250 s on the side to which the heat-sensitive layer is applied.

Such a heat-sensitive recording material has the advantage of a high dynamic sensitivity.

It is advantageous to provide a smooth web-like carrier material and to maintain this smoothness over the individual coatings. The smoother the substrate is built up from below, the better is the final smoothness and therefore the sensitivity of the end product.

It is preferred that each layer applied to the web-like carrier material has a Bekk smoothness on its upper side, i.e., on the side not facing the web-like carrier material, which is at least as great or greater than that of the respective layer below.

Preferably, each layer applied to the web-like carrier material has a Bekk smoothness of at least 5% (percentage increase) on its upper side, i.e., on the side not facing the web-like carrier material, compared to the respective layer below.

Preferably, each layer applied to the web-like carrier material has a Bekk smoothness of at least 5% (absolute increase) on its upper side, i.e., on the side not facing the web-like carrier material, compared to the respective layer below.

The heat-sensitive recording material according to the invention can be obtained using known manufacturing processes.

The present invention also relates to a manufacturing process for a heat-sensitive recording material as described above.

It is preferred to obtain the heat-sensitive recording material according to the invention by a process in which (aqueous) suspensions comprising the starting materials of the individual layers are successively applied to the web-like carrier material, the (aqueous) application suspensions having a solids content of 8 to 50% by weight, preferably of 10 to 40% by weight, and being applied by the curtain coating process at an operating speed of the coating system of at least 200 m/min.

Alternatively, the (aqueous) suspensions, comprising the starting materials of the respective layers, can also be applied with a blade.

This process is particularly advantageous from an economic point of view and due to the even application over the web-like carrier material.

If the solids content falls below a value of around 8% by weight, the economic efficiency deteriorates because a large amount of water has to be removed in a short time by gentle drying, which has a detrimental effect on the coating speed. If, on the other hand, the value of 60% by weight is exceeded, this merely leads to increased technical effort to ensure the stability of the coating color curtain during the coating process and the drying of the applied film, as the machine has to run very quickly again in this case.

In the curtain coating process, a free-falling curtain of a coating dispersion is formed. The coating dispersion in the form of a thin film (curtain) is “poured” onto a substrate by free fall in order to apply the coating dispersion to the substrate. DE 10 196 052 T1 discloses the use of the curtain coating process in the production of information recording materials, wherein multilayer recording layers are realized by applying the curtain, which consists of several coating dispersion films, to substrates.

Embodiments of the process according to the invention in which a “double curtain” is used may also be contemplated. This means that two successive coats are applied one immediately after the other. The application is carried out in such immediate succession that the first layer applied has not yet dried before the next layer is applied. The two layers are therefore preferably applied “wet on wet”.

All definitions relating to the curtain coating process apply analogously to the double curtain coating process.

The advantage of a “wet-on-wet” application using a double curtain coating process is that the two layers have a stronger bonding and, more particularly, there is no need for intermediate adhesion promoters.

In a preferred embodiment of the process according to the invention, the aqueous, deaerated application suspension has a viscosity of about 100 to about 1000 mPas (Brookfield, 100 rpm, 20° C.). If the value drops below about 100 mPas or exceeds about 1000 mPas, this leads to poor runnability of the coating mass on the coating unit. Particularly preferably, the viscosity of the aqueous, deaerated application suspension is about 200 to about 500 mPas. The viscosities of successive coating masses in the double curtain should decrease from bottom to top. Incorrectly adjusted coatings increase the probability of heeling at the point of impact of the curtain as well as the occurrence of “wetting faults”.

In a preferred embodiment, the surface tension of the aqueous application suspension can be adjusted to about 25 to about 70 mN/m, preferably to about 35 to about 60 mN/m (measured in accordance with the standard for bubble pressure tensiometry (ASTM D 3825-90), as described below), in order to optimize the process. Better control over the coating process can be achieved by determining the dynamic surface tension of the coating color and adjusting it by selecting the appropriate surfactant and determining the required amount of surfactant.

The dynamic surface tension is measured using a bubble pressure tensiometer. The maximum internal pressure of a gas bubble formed via a capillary in a liquid is measured. The internal pressure p of a spherical gas bubble (Laplace pressure) depends on the radius of curvature r and the surface tension σ according to the Young-Laplace equation:

$$p = \frac{2 σ}{r}$$

When a gas bubble is produced at the tip of a capillary in a liquid, the curvature first increases and then decreases again, resulting in the occurrence of a pressure maximum of. The greatest curvature and thus the greatest pressure occur when the radius of curvature corresponds to the capillary radius.

Pressure characteristics for the bladder pressure measurement, position of the pressure maximum:

The radius of the capillary is determined using a reference measurement carried out with a liquid with a known surface tension, usually water. Once the radius is known, the surface tension can be calculated from the maximum pressure, pmax. Since the capillary is immersed in the liquid, the hydrostatic pressure p0 resulting from the immersion depth and the density of the liquid must be subtracted from the measured pressure (this is done automatically with modern instruments). This results in the following formula for the bubble pressure process:

$$σ = \frac{( \text{?} - \text{?} ) \cdot r}{2}$$

$$\text{?} \text{indicates text missing or illegible when filed}$$

The measured value corresponds to the surface tension at a certain surface age, the time from the start of bubble formation to the occurrence of the pressure maximum. By varying the speed at which the bubbles are produced, the dependence of the surface tension on the surface age can be acquired, resulting in a curve in which the surface tension is plotted against time.

This dependency plays an important role in the use of surfactants, as the equilibrium value of the interfacial tension is not even reached in many processes due to the sometimes low diffusion and adsorption rates of surfactants.

The individual layers can be formed on-line or in a separate off-line coating process.

In particular, to ensure that the layers described in detail above exhibit the aforementioned Bekk smoothing, the following process steps are preferably carried out.

The web-like carrier material is preferably smoothed in a first cylinder. This one-sided or two-sided high smoothness, which is produced by this process technology, already provides the web-like carrier material with an advantage. Additional calendaring by a downstream calendar, preferably before a first coater, can further improve smoothness and/or ensure a good profile.

If a starch coating as defined above is applied, this is preferably done using a film press before the color layer is applied using a blade coater.

The starch on the back side is particularly advantageous to prevent the coating color from penetrating the blade coater.

It would also be possible to apply the color layer directly with a film press. However, there would be a disadvantage in terms of smoothness compared to a blade coater. The use of a blade coater gives the material a good basic smoothness for the important dynamic sensitivity of the end product. There is a correlation between final smoothness and dynamic sensitivity.

It could also be contemplated to apply the color layer with a film press or even with a curtain coater. The advantage of smoothness is then lost, but this could be compensated, more particularly when using a film press, with a calendar. However, this is only appropriate if no hollow spheres are used, as these would be destroyed by the film press.

The insulating layer, if present, is applied in the same way.

The siliconized layer, if present, is also applied in the same way.

The same applies to the protective layer, if present. If available, the protective layer can alternatively be printed on. In terms of processing and technological properties, protective coatings that can be cured using actinic radiation are particularly suitable. The term “actinic radiation” refers to UV or ionizing radiation, such as electron beams.

The heat-sensitive layer is preferably applied by means of curtain coating, as described above.

If web-like carrier materials, more particularly papers, are coated on one side, the resulting curl should then be evened out.

This is preferably done with an LAS moisturizer (LAS Liquid Applicator System). To do this, a film of water is applied to the lesser coated side and then dried.

This restores the so-called flat position. When the water film is applied, the surface deteriorates slightly.

A preferred option for protecting the surface would be a steam humidifier. Instead of water, steam is blown on. This does not damage the surface. This is very suitable for applications where the highest surface quality must be achieved.

Another option would be a spray humidifier, where a water mist is applied.

All of the above layers can be single or multi-layered.

The present invention further relates to a heat-sensitive recording material obtainable by the process described above.

The present invention also relates to the use of a heat-sensitive recording material as described above as a receipt roll, as an adhesive label (roll), also in refrigeration and deep-freeze applications, and as a ticket (roll). In particular, these have a functional side and/or back side (with color, colored, black/grey) and can be pre-printed. These rolls are preferably available in typical widths and lengths.

The present invention also relates to a process for decoloring a heat-sensitive recording material with a web-like support material, a color layer on one side of the web-like support material, and a heat-sensitive layer on the color layer such that the color layer is at least partially covered,

wherein the heat-sensitive layer is configured to become translucent when exposed to localized heat such that the underlying color layer becomes visible, more particularly as defined above, to obtain a fibrous material mixture comprising the steps of
Providing a mixture of the heat-sensitive recording material and at least one other paper type, more particularly at least one waste paper type;
Decoloring of the mixture in a deinking process in order to obtain a fibrous material mixture.

The heat-sensitive recording material decolored by this process preferably comprises or is a heat-sensitive recording material as described above. All definitions and embodiments of the heat-sensitive recording material therefore apply analogously to the process according to the invention for decoloring a heat-sensitive recording material.

A deinking process is preferably characterized by the following features.

After removing foreign bodies such as staples, the paper is preferably mechanically shredded or defibered and mixed with water.

The resulting waste paper fibrous mixture can be subjected to so-called flotation. Chemical substances are added to it, preferably in several processes, for example:
complexing agents,
caustic soda,
flocculants,
surfactants,
water glass, and/or
hydrogen peroxide.

In flotation, the other particles present in the stock suspension after the shredding or defibrating stage and separated from the fibers, such as color particles or fillers, are adsorb to air bubbles in the flotation process by collector chemicals and transported by these to the surface of a flotation cell. The result is a dirt-laden foam known as flotate, which may also contain fibers and fillers in addition to the detached color particles. This foam is skimmed off, cleaned, and can be used as ash in paper production.

The flotation is preferably further characterized in that the flotate is obtained by compressed air supply and addition of flocculant.

A mixture of fibers remains.

This remaining fibrous material mixture is preferably as free as possible from the at least one dye.

This process can be repeated depending on the desired degree of whiteness of the new paper.

If the new paper is to be light gray or white, the fibrous material mixture can be further bleached with oxygen or hydrogen peroxide after deinking.

Furthermore, virgin fibers (primary or secondary fibers) can preferably be added to the fibrous material mixture, because after five to seven recycling runs, the individual fibers are often too short and fragile to ensure the stability of the recycled paper.

As primary fibrous mixtures, wood pulps such as spruce and pine and short-fiber fibrous mixtures such as birch, beech, aspen, oak, eucalyptus, or mixtures of these can be used.

In principle, all known secondary fibrous mixtures can be used as secondary fibrous mixtures.

The process according to the invention for decoloring a heat-sensitive recording material is further preferably characterized by the following steps.
i) Providing a mixture of the heat-sensitive recording material and at least one other paper type, more particularly at least one waste paper type, wherein a specific quantity of the at least one other paper type, more particularly of the at least one waste paper type, is selected;
ii) Working up of a sample of the mixture according to INGEDE Method 11 (Issue 2, January 2017),
iii) Determining the and determining the following scores according to the Assessment of Printed Product Recyclability, Deinkability Score:
a) Luminosity Y maximum of 35 points,
b) Color coefficient a* in the CIELAB system maximum of 20 points,
c) Dirt specks A in the two different size classes A50 maximum of 15 points and A250 maximum of 10 points,
d) Degree of dye elimination (ink elimination) IE maximum of 10 points, and
e) Filtrate darkening ΔY maximum of 10 points,
where the sum of all points is in the range from 0 to 100, preferably in the range from 51 to 70, particularly preferably in the range from 71 to 100 and/or preferably no individual point value is negative;
iv) Decoloring the mixture by a deinking process as described above, provided that the sample of the mixture has achieved a predetermined number of points in order to obtain a fibrous material mixture; or

Starting again with step i) by adding a further quantity of at least one paper type if the sample has not yet achieved a predetermined number of points.

Preferably, the sum of all points is in the range from 0 to 50, preferably in the range from 51 to 70, particularly preferably in the range from 71 to 100.

Preferably, no individual point value is negative.

Most particularly preferably, the sum of all points is in the range from 0 to 50, preferably in the range from 51 to 70, particularly preferably in the range from 71 to 100, and no individual point value is negative.

The present invention also relates to a fibrous material mixture obtainable by the process described above.

The present invention further relates to a process for producing a recycled paper, comprising the steps of:
Decoloring a heat-sensitive recording material according to the process described above in order to obtain a fibrous material mixture; and
Producing a recycled paper comprising the fibrous material mixture, preferably with the addition of additional primary fibrous material or secondary or waste paper fibrous material, comprising compressing and dewatering the fibrous material mixture optionally containing the additional primary fibrous material or secondary or waste paper fibrous material.

All definitions and embodiments of the heat-sensitive recording material and the process for decoloring a heat-sensitive recording material therefore apply analogously to the process for producing a recycled paper.

As primary fibrous mixtures, wood pulps such as spruce and pine and short-fiber fibrous mixtures such as birch, beech, aspen, oak, eucalyptus, or mixtures of these can be used.

In principle, all known secondary fibrous mixtures can be used as secondary fibrous mixtures.

In principle, all known types of waste paper can be used.

The fibrous mixture stream preferably comprises fibrous mixtures that are certified according to FSC and PFSC.

The production of a recycled paper, comprising the compressing and dewatering of the fibrous material mixture, is fundamentally known to those skilled in the art, and is preferably characterized by the following features.

First, a fibrous material stream is provided.

This fibrous material mixture stream is fed, preferably in this order, into at least one headbox, into at least one wire section for forming a fibrous material mixture web, into at least one press section and into at least one dryer section with dryer groups.

The headbox is usually a type of nozzle by means of which the fibrous mixture flow is applied evenly across the width in quantity and consistency to an endless circulating screen through which the solids are separated from the water content. During the dewatering process, a uniform fiber mat is formed on the wire, which is the starting base for the subsequent paper.

In the press section, the fiber mat produced in the wire section is preferably dewatered further. This is usually pressed out with the help of felts. This can be done, for example, between two rollers pressed together. The felts used here have the function of transporting the web through the press section without destroying it, and absorbing the water pressed out in the press nip.

The dryer section usually consists mainly of steam-heated cylinders that are brought into contact with the paper web in order to heat it up to such an extent that the water still in the paper web evaporates to the desired final moisture content. These successive drying cylinders are preferably combined into so-called drying groups. Steam can be applied to these drying groups in different ways in order to be able to control the drying process.

The fibrous material web can then be smoothed if necessary and then fed to a reel to make storage and/or transportation easier.

The present invention further relates to a recycled paper obtainable according to the process described above.

All definitions and embodiments of the heat-sensitive recording material, the process for decoloring a heat-sensitive recording material and the process for producing a recycled paper therefore apply analogously to the recycled paper obtainable according to the process described above.

Particularly preferred embodiments of the invention are explained in more detail below.

A particularly preferred first embodiment comprises a heat-sensitive recording material with a web-like carrier material, a color layer applied thereto and a heat-sensitive layer on the color layer.

In this first embodiment, the web-like carrier material comprises a paper.

In this first embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer

In another embodiment, carbon black is present in the color layer in an amount of less than 2% by weight, based on the total heat-sensitive recording material.

In this first embodiment, the heat-sensitive layer comprises the above-mentioned embodiments.

A particularly preferred second embodiment comprises a heat-sensitive recording material with a web-like carrier material, an insulating layer applied thereto, a color layer applied to the insulating layer and a heat-sensitive layer on the color layer.

In this second embodiment, the web-like carrier material comprises paper.

In this second embodiment, the insulating layer comprises a thermally insulating material, preferably kaolin, particularly preferably calcined kaolin, and mixtures thereof, or hollow sphere pigments, more particularly hollow sphere pigments comprising a styrene-acrylate copolymer.

In this second embodiment, the color layer comprises substantive dyes, water flexo dyes, graphite, sulfur dyes, iron gall inks, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer

In another embodiment, carbon black is present in the color layer in an amount of less than 2% by weight, based on the total heat-sensitive recording material.

In this second embodiment, the heat-sensitive layer comprises the aforementioned embodiments.

A particularly preferred third embodiment comprises a heat-sensitive recording material with a web-like carrier material, a color layer applied thereto, which is also an insulating layer, and a heat-sensitive layer on the color layer.

In this third embodiment, the web-like carrier material comprises paper.

In this third embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer

In another embodiment, carbon black is present in the color layer in an amount of less than 2% by weight, based on the total heat-sensitive recording material.

In this third embodiment, the color layer, which is also an insulating layer, comprises a heat-insulating material, preferably kaolin, particularly preferably calcined kaolin, and mixtures thereof, or hollow sphere pigments, more particularly hollow sphere pigments comprising a styrene-acrylate copolymer.

In this third embodiment, the heat-sensitive layer comprises the aforementioned embodiments.

A particularly preferred fourth embodiment comprises a heat-sensitive recording material with a web-like carrier material having a starch precoat on both sides, a color layer applied thereto and a heat-sensitive layer on the color layer.

In this fourth embodiment, the web-like carrier material comprises paper.

In this fourth embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer.

In another embodiment, carbon black is present in the color layer in an amount of less than 2% by weight, based on the total heat-sensitive recording material.

In this fourth embodiment, the heat-sensitive layer comprises the aforementioned embodiments.

A particularly preferred fifth embodiment comprises a heat-sensitive recording material having a web-like carrier material, a color layer applied thereto and a heat-sensitive layer on the color layer, wherein a protective layer is applied to the heat-sensitive layer.

In this fifth embodiment, the web-like carrier material comprises paper.

In this fifth embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer.

In another embodiment, carbon black is present in the color layer in an amount of less than 2% by weight, based on the total heat-sensitive recording material.

In this fifth embodiment, the heat-sensitive layer comprises the aforementioned embodiments.

In this fifth embodiment, the protective layer comprises at least one binder and at least one pigment, particularly preferably an inorganic pigment.

A particularly preferred sixth embodiment comprises a heat-sensitive recording material with a web-like carrier material, an insulating layer applied thereto, a color layer applied to the insulating layer, and a heat-sensitive layer applied to the color layer, wherein a protective layer is applied to the heat-sensitive layer.

In this sixth embodiment, the web-like carrier material comprises paper.

In this sixth embodiment, the insulating layer comprises a thermally insulating material, preferably kaolin, particularly preferably calcined kaolin, and mixtures thereof, or hollow sphere pigments, more particularly hollow sphere pigments comprising a styrene-acrylate copolymer.

In this sixth embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer.

In another embodiment, carbon black is present in the color layer in an amount of less than 2% by weight, based on the total heat-sensitive recording material.

In this sixth embodiment, the heat-sensitive layer comprises the aforementioned embodiments.

In this sixth embodiment, the protective layer preferably comprises at least one binder and at least one pigment, particularly preferably an inorganic pigment.

A particularly preferred seventh embodiment comprises a heat-sensitive recording material with a web-like carrier material, a color layer applied thereon which is also an insulating layer, and a heat-sensitive layer on the color layer, wherein a protective layer is applied on the heat-sensitive layer.

In this seventh embodiment, the web-like carrier material comprises paper.

In this seventh embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer.

In another embodiment, carbon black is present in the color layer in an amount of less than 2% by weight, based on the total heat-sensitive recording material.

In this seventh embodiment, the color layer, which is also an insulating layer, comprises a thermally insulating material, preferably kaolin, particularly preferably calcined kaolin, and mixtures thereof, or hollow sphere pigments, more particularly hollow sphere pigments comprising a styrene-acrylate copolymer.

In this seventh embodiment, the heat-sensitive layer comprises the aforementioned embodiments.

In this seventh embodiment, the protective layer preferably comprises at least one binder and at least one pigment, particularly preferably an inorganic pigment.

A particularly preferred eighth embodiment comprises a heat-sensitive recording material with a web-like carrier material having a starch precoat on both sides, a color layer applied thereon, and a heat-sensitive layer on the color layer, wherein a protective layer is applied to the heat-sensitive layer.

In this eighth embodiment, the web-like carrier material comprises paper.

In this eighth embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer.

In another embodiment, carbon black is present in the color layer in an amount of less than 2% by weight, based on the total heat-sensitive recording material.

In this eighth embodiment, the heat-sensitive layer comprises the aforementioned embodiments.

In this eighth embodiment, the protective layer preferably comprises at least one binder and at least one pigment, particularly preferably an inorganic pigment.

A particularly preferred ninth embodiment comprises a heat-sensitive recording material having a web-like carrier material, an adhesive layer on the lower side and a color layer applied to the other side of the web-like carrier material, and a heat-sensitive layer on the color layer, wherein a siliconized layer is applied to the heat-sensitive layer.

In this ninth embodiment, the adhesive layer comprises an adhesive, preferably a thermosetting adhesive, more particularly a pressure-sensitive adhesive.

In this ninth embodiment, the web-like carrier material comprises paper.

In this ninth embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer.

In another embodiment, carbon black is present in the color layer in an amount of less than 2% by weight, based on the total heat-sensitive recording material.

In this ninth embodiment, the heat-sensitive layer comprises the aforementioned embodiments.

In this ninth embodiment, the siliconized layer comprises at least one siloxane, preferably a poly(organo)siloxane.

A particularly preferred tenth embodiment comprises a heat-sensitive recording material having a web-like carrier material, an adhesive layer on the lower side and an insulating layer applied to the other side of the web-like carrier material, a color layer applied to the insulating layer, and a heat-sensitive layer on the color layer, wherein a siliconized layer is applied to the heat-sensitive layer.

In this tenth embodiment, the adhesive layer comprises an adhesive, preferably a thermosetting adhesive, more particularly a pressure-sensitive adhesive.

In this tenth embodiment, the web-like carrier material comprises paper.

In this tenth embodiment, the insulating layer comprises a thermally insulating material, preferably kaolin, particularly preferably calcined kaolin, and mixtures thereof, or hollow sphere pigments, particularly hollow sphere pigments comprising a styrene-acrylate copolymer.

In this tenth embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer.

In another embodiment, carbon black is present in the color layer in an amount of less than 2% by weight, based on the total heat-sensitive recording material.

In this tenth embodiment, the heat-sensitive layer comprises the aforementioned embodiments.

In this tenth embodiment, the siliconized layer comprises at least one siloxane, preferably a poly(organo)siloxane.

A particularly preferred eleventh embodiment comprises a heat-sensitive recording material having a web-like carrier material, an adhesive layer on the lower side and a color layer applied to the other side of the web-like carrier material, which is also an insulating layer, and a heat-sensitive layer on the color layer, wherein a siliconized layer is applied to the heat-sensitive layer.

In this eleventh embodiment, the adhesive layer comprises an adhesive, preferably a thermosetting adhesive, more particularly a pressure-sensitive adhesive.

In this eleventh embodiment, the web-like carrier material comprises paper.

Embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer.

In another embodiment, carbon black is present in the color layer in an amount of less than 2% by weight, based on the total heat-sensitive recording material.

In this eleventh embodiment, the color layer, which is also an insulating layer, comprises a thermally insulating material, preferably kaolin, particularly preferably calcined kaolin, and mixtures thereof, or hollow sphere pigments, more particularly hollow sphere pigments comprising a styrene-acrylate copolymer.

In this eleventh embodiment, the heat-sensitive layer comprises the aforementioned embodiments.

In this eleventh embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer.

In another embodiment, carbon black is present in the color layer in an amount of less than 2% by weight, based on the total heat-sensitive recording material.

In this eleventh embodiment, the siliconized layer comprises at least one siloxane, preferably a poly(organo)siloxane.

A particularly preferred twelfth embodiment comprises a heat-sensitive recording material with a web-like carrier material having a starch precoat on both sides, an adhesive layer on the lower side and a color layer applied to the other side of the web-like carrier material, and a heat-sensitive layer on the color layer, wherein a siliconized layer is applied to the heat-sensitive layer.

In this twelfth embodiment, the adhesive layer comprises an adhesive, preferably a thermosetting adhesive, more particularly a pressure-sensitive adhesive.

In this twelfth embodiment, the web-like carrier material comprises paper.

In this twelfth embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer.

In another embodiment, carbon black is present in the color layer in an amount of less than 2% by weight, based on the total heat-sensitive recording material.

In this twelfth embodiment, the heat-sensitive layer comprises the aforementioned embodiments.

In this twelfth embodiment, the siliconized layer comprises at least one siloxane, preferably a poly(organo)siloxane.

A particularly preferred thirteenth embodiment comprises a heat-sensitive recording material with a web-like carrier material having a starch precoat on both sides, an adhesive layer on the lower side and a color layer applied to the other side of the web-like carrier material, and a heat-sensitive layer on the color layer, wherein a protective layer is applied to the heat-sensitive layer and a siliconized layer is applied thereon.

In this thirteenth embodiment, the adhesive layer comprises an adhesive, preferably a thermosetting adhesive, more particularly a pressure-sensitive adhesive.

In this thirteenth embodiment, the web-like carrier material comprises paper.

In this thirteenth embodiment, the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer.

In another embodiment, carbon black is present in the color layer in an amount of less than 2% by weight, based on the total heat-sensitive recording material.

In this thirteenth embodiment, the heat-sensitive layer comprises the aforementioned embodiments.

In this thirteenth embodiment, the protective layer preferably comprises at least one binder and at least one pigment, particularly preferably an inorganic pigment.

In this thirteenth embodiment, the siliconized layer comprises at least one siloxane, preferably a poly(organo)siloxane

A particularly preferred fourteenth embodiment comprises a heat-sensitive recording material with a web-like carrier material, a color layer applied thereto and a heat-sensitive layer on the color layer, wherein the heat-sensitive layer comprises only a wax.

In this fourteenth embodiment, the web-like carrier material comprises paper.

In this fourteenth embodiment, the embodiment comprises the color layer comprises substantive dyes, water flexo dyes, graphite, sulfur dyes, iron gall ink, inorganic and/or organic pigment dyes and/or iron oxide (Fe₃O₄).

Alternatively, carbon black may be present in the color layer in an amount of 2 to 24% by weight, preferably 2 to 19% by weight, particularly preferably 10 to 24% by weight or 10 to 19% by weight, based on the total solids content of the color layer.

In another embodiment, carbon black is present in the color layer in an amount of less than 2% by weight, based on the total heat-sensitive recording material.

The embodiments mentioned in the preferred embodiments one to thirteen described above with respect to the heat-sensitive layer include more particularly the following embodiments:

The heat-sensitive layer comprises at least one polymer particle having a glass transition temperature of −55° to 130° C., preferably of 40° to 80° C.

The heat-sensitive layer comprises at least one polymer particle having a core/shell structure, wherein the polymer particles are selected from the group consisting of (i) polymer particles having an outer polymer shell with a glass transition temperature of 40° to 800° C. and (ii) polymer particles having an inner polymer shell with a glass transition temperature of 40° to 130° C. and an outer polymer shell with a glass transition temperature of −55° to 50° C., wherein the glass transition temperature of the outer polymer shell is preferably lower than that of the inner polymer shell.

The heat-sensitive layer comprises at least one polymer particle with a melting temperature of less than 250° C., preferably from 0° to 250° C.

The heat-sensitive layer comprises at least one polymer particle with an average particle size in the range from 0.1 to 2.5 μm.

### DESCRIPTION OF THE FIGURES

The following figures schematically illustrate various layer structures for exemplary heat-sensitive recording materials according to the invention. The composition of the individual layers is to be understood as defined above for each layer.

FIG. 1: Heat-sensitive recording material with a web-like carrier material, a color layer applied thereto, and a heat-sensitive layer on the color layer.

FIG. 2: Heat-sensitive recording material with a web-like carrier material, an insulating layer applied thereto, a color layer applied to the insulating layer, and a heat-sensitive layer on the color layer.

FIG. 3: Heat-sensitive recording material with a web-like carrier material, a color layer applied thereto, which is also an insulating layer, and a heat-sensitive layer on the color layer.

FIG. 4: Heat-sensitive recording material with a web-like carrier material having a starch precoat on both sides, a color layer applied thereto, and a heat-sensitive layer on the color layer.

FIG. 5: Heat-sensitive recording material with a web-like carrier material, a color layer applied thereto, and a heat-sensitive layer on the color layer, wherein a protective layer is applied to the heat-sensitive layer.

FIG. 6: A heat-sensitive recording material with a web-like carrier material, an insulating layer applied thereto, a color layer applied to the insulating layer, and a heat-sensitive layer applied to the color layer, wherein a protective layer is applied to the heat-sensitive layer.

FIG. 7: Heat-sensitive recording material with a web-like carrier material, a color layer applied thereto, which is also an insulating layer, and a heat-sensitive layer on the color layer, wherein a protective layer is applied to the heat-sensitive layer.

FIG. 8: Heat-sensitive recording material comprising a web-like carrier material having a starch precoat on both sides, a color layer applied thereto, and a heat-sensitive layer on the color layer, wherein a protective layer is applied to the heat-sensitive layer.

FIG. 9: Heat-sensitive recording material with a web-like carrier material, an adhesive layer on the lower side, and a color layer applied to the other side of the web-like carrier material, and a heat-sensitive layer on the color layer, wherein a siliconized layer is applied to the heat-sensitive layer.

FIG. 10: Heat-sensitive recording material with a web-like carrier material, an adhesive layer on the lower side and an insulating layer applied to the other side of the web-like carrier material, a color layer applied to the insulating layer, and a heat-sensitive layer on the color layer, wherein a siliconized layer is applied to the heat-sensitive layer.

FIG. 11: Heat-sensitive recording material with a web-like carrier material, an adhesive layer on the lower side, and a color layer applied to the other side of the web-like carrier material, which is also an insulating layer, and a heat-sensitive layer on the color layer, wherein a siliconized layer is applied to the heat-sensitive layer.

FIG. 12: Heat-sensitive recording material with a web-like carrier material having a starch precoat on both sides, an adhesive layer on the lower side and a color layer applied to the other side of the web-like carrier material, and a heat-sensitive layer on the color layer, wherein a siliconized layer is applied to the heat-sensitive layer.

FIG. 13: Heat-sensitive recording material with a web-like carrier material having a starch precoat on both sides, an adhesive layer on the lower side, and a color layer applied to the other side of the web-like carrier material, and a heat-sensitive layer on the color layer, wherein a protective layer is applied to the heat-sensitive layer and a siliconized layer is applied thereon.

FIG. 14: Measurement of the dynamic sensitivity of heat-sensitive recording materials, wherein the carrier material has different Bekk smoothnesses. The dynamic sensitivity (optical density (ODU)) is shown as a function of the current energy E of three recording materials with different base papers:

A: Uncalendared, smoothness 210 Bekk [s],
B: Calendared, line pressure 0.5 bar, smoothness 490 Bekk [s],
C: Calendared, line pressure 2×10 bar, smoothness 1276 Bekk [s].

### EXAMPLES

The invention is explained in more detail below with reference to several non-limiting examples:

Heat-sensitive recording materials according to the invention were prepared with the dyes and/or binders or binder concepts according to Tables 13 to 19 (comparative example and examples E1 to E39). These were produced according to the exemplary embodiment 2, wherein changes in the percentage of individual formulation components, such as the percentage of the dye, were balanced out using the inorganic pigment calcium carbonate.

For this purpose, the color layer was applied to the paper substrate on a paper coating machine using a curtain coater. After the application, the drying process of the respective coated paper carrier is carried out in the conventional manner without negatively affecting the properties of the heat-sensitive recording material according to the invention, such as the surface whiteness or paper whiteness of the heat-sensitive layer.

Then, in accordance to INGEDE Method 11, the scores also listed in Tables 13 to 19 were determined in accordance with the Assessment of Printed Product Recyclability, Deinkability Score and the heat-sensitive recording material was finally evaluated.

It was also tested whether the heat-sensitive recording material is recyclable and meets at least one of the following recyclability criteria:
a) In an initial mixture consisting of 100% wood-free, uncoated copy paper with a dry toner printed on both sides and a coverage of 5% (CEN_TEST Master from EN 12281) per side, the addition of 1% heat-sensitive recording material only worsens the light reflectance value after flotation by a maximum of 6 points and the filtrate darkening by a maximum of 3 points compared to the floated initial mixture without heat-sensitive recording material;
and/or
b) in an initial waste paper mixture of newspapers/magazines (offset, uncoated) in a ratio of 60%/40%, the addition of 5% heat-sensitive recording material only worsens the light reflectance value after flotation by a maximum of 6 points and the filtrate darkening by a maximum of 3 points compared to the floated initial mixture without heat-sensitive recording material.

The result of the recyclability test is shown in Tables 13 to 19 in the column Assessment or Note, respectively.

The process for decoloring the heat-sensitive recording materials in order to obtain a fibrous material mixture comprised the steps:
Providing a mixture of the heat-sensitive recording material and at least one other paper type, more particularly at least one waste paper type;
Decoloring the mixture in a deinking process in order to obtain a fibrous material mixture.

Heat-sensitive recording materials according to the invention were prepared with the basic compositions according to Tables 1 to 12. Further examples and modifications of these compositions are listed in Tables 13 to 19.

In all examples, a paper substrate made of hardwood and softwood pulp with a specific basis weight of 41 or 58 g/m² is used as the carrier material.

All indicated basis weights refer to the respective dried layer.

The dry contents (TG) of the respective coating formulations are adjusted by adding water as follows: Insulating layer (30%), color layer (26%), heat-sensitive layer (20%) and protective layer (10%).

The raw materials are used as a dispersion or solution with the following dry contents: Ropaque HP-1055 (21%), styrene butadiene latex (48%), dyes, more particularly according to tables 1 to 4 (generally 45%; for E1 the amount of dye was approximately halved), Ropaque OP-96 (30%), sodium metaborate tetrahydrate (2%), stearic acid amide wax (22%), silicon oxide (28%), zinc stearate (35%), polyvinyl alcohol (high viscosity) (10%), calcined kaolin (45%), precipitated calcium carbonate (58%), ammonium zirconium carbonate (9%), polyvinyl alcohol (low viscosity) (7%), and kaolin (75%).

The quantities [% by weight] refer to the oven-dry state (ods).

### 1. Example 1

In exemplary embodiment 1, the color layer and the heat-sensitive layer are applied consecutively by a single and/or simultaneously by a double curtain coater to the paper substrate at a speed of 900 m/min on a paper coating machine. Each application is followed in a conventional manner by the drying process of the respective coated paper substrate.

TABLE 1
Composition of the individual layers of the heat-sensitive
recording material according to example 1.
Example 1 (FIG. 3)

| | Formulation | Formulation | | |
|---|---|---|---|---|
| Layer | ingredient | ingredient | | Quantity |
| basis weight | Trade name | Chemical name | Function | % by wt.] |
| Color layer | Ropaque HP-1055, | Styrene-acrylate | Polymer | 52.3 |
| 5.2 g/m² | Dow Co. | copolymer | particles | |
| | Latex, Styron Co. | Styrene-butadiene | Binder | 25.7 |
| | | latex | | |
| | | Dye | Dye/color | 21.2 |
| | | | pigment | |
| | n.a. | n.a. | Rheology | Balance |
| | | | additives | |
| Heat-sensitive | Ropaque OP-96, | Styrene-acrylate | Polymer | 35.1 |
| layer | Dow Co. | copolymer | particles | |
| 3.5 g/m² | | Sodium metaborate | Crosslinker | 0.7 |
| | | tetrahydrate | | |
| | Chukyo Co. | Stearic acid | Heat-sensitive | 40.4 |
| | | amide wax | material | |
| | | Silicon oxide | Inorganic | 9.0 |
| | | | pigment | |
| | | Zinc stearate | Lubricant/ | 3.2 |
| | | | release agent | |
| | Poval, | Polyvinyl alcohol, | Binder | 8.3 |
| | Kuraray Co. | highly saponified, | | |
| | | high viscosity | | |
| | n.a. | n.a. | Rheology | Balance |
| | | | additives | |

n.a.: Common materials known to those skilled in the art.

In order to improve certain coating properties, additional components, more particularly rheology additives such as thickeners and/or surfactants, are added to the individual layers. The additional components are added in such quantities that the % by weight of the respective layer adds up to 100% by weight. The corresponding quantities are familiar to those skilled in the art.

### 2. Example 2

In exemplary embodiment 2, a starch precoat (0.5 g/m²) is applied to the front and back of the paper substrate on a paper machine using a film press at a speed of 800 m/min. The color layer is applied to the starch-coated paper substrate on a paper coating machine using a blade coater and the heat-sensitive layer is applied using a curtain coater at a speed of 900 n/min. Each application is followed in a conventional manner by the drying process of the respective coated paper substrate.

TABLE 2
Composition of the individual layers of the heat-sensitive
recording material according to example 2.
Example 2 (FIG. 4)

| | Formulation | Formulation | | |
|---|---|---|---|---|
| Layer | ingredient | ingredient | | Quantity |
| basis weight | Trade name | Chemical name | Function | % by wt.] |
| Color layer | | Calcined kaolin | Inorganic pigment | 48.2 |
| 7.0 g/m² | | Precipitated | Inorganic pigment | 22.9 |
| | | calcium carbonate, | | |
| | | calcite type | | |
| | Latex, Styron Co. | Styrene-butadiene | Binder | 8.6 |
| | | latex | | |
| | | Dye | Dye/color pigment | 19.0 |
| | n.a. | n.a. | Rheology additives | Balance |
| Heat-sensitive | Ropaque OP-96, | Styrene-acrylate | Polymer particles | 36.1 |
| layer | Dow Co. | copolymer | | |
| 3.5 g/m² | | Sodium metaborate | Crosslinker | 0.5 |
| | | tetrahydrate | | |
| | Chukyo Co. | Stearic acid | Heat-sensitive | 40.4 |
| | | amide wax | material | |
| | | Silicon oxide | Inorganic pigment | 8.0 |
| | | Zinc stearate | Lubricant/release | 3.9 |
| | | | agent | |
| | Poval, Kuraray Co. | Polyvinyl alcohol, | Binder | 10.3 |
| | | highly saponified, | | |
| | | high viscosity | | |
| | n.a. | n.a. | Rheology additives | Balance |

n.a.: Common materials known to those skilled in the art.

In order to improve certain coating properties, additional components, more particularly rheology additives such as thickeners and/or surfactants, are added to the individual layers. The additional components are added in such quantities that the % by weight of the respective layer adds up to 100% by weight. The corresponding quantities are familiar to those skilled in the art.

### 3. Example 3

In exemplary embodiment 3, a starch precoat (0.5 g/m²) is applied to the front and back of the paper substrate on a paper machine using a film press at a speed of 800 m/min. The color layer is applied to the starch-coated paper substrate on a paper coating machine using a blade coater at a speed of 600 m/min. To the starch-coated paper substrate with a color layer, the heat-sensitive layer and the protective layer are applied consecutively using a single and/or simultaneously using a double curtain coater at a speed of 900 m/min on a paper coating machine. Each application is followed in a conventional manner by the drying process of the respective coated paper substrate.

TABLE 3
Composition of the individual layers of the heat-sensitive
recording material according to example 3.
Example 3 (FIG. 8)

| | Formulation | Formulation | | |
|---|---|---|---|---|
| Layer | ingredient | ingredient | | Quantity |
| basis weight | Trade name | Chemical name | Function | % by wt. ] |
| Color layer | | Calcined kaolin | Inorganic pigment | 52.2 |
| 7.0 g/m² | | Precipitated calcium | Inorganic pigment | 16.9 |
| | | carbonate, calcite | | |
| | | type | | |
| | Latex, Styron Co. | Styrene-butadiene | Binder | 12.6 |
| | | latex | | |
| | | Dye | Dye/color | 19.0 |
| | | | pigment | |
| | n.a. | n.a. | Rheology additives | Balance |
| Heat-sensitive | Ropaque OP-96, | Styrene-acrylate | Polymer particles | 38.5 |
| layer | Dow Co. | copolymer | | |
| 3.5 g/m² | | Ammonium zirconium | Crosslinker | 0.9 |
| | | carbonate | | |
| | Chukyo Co. | Stearic acid amide | Heat-sensitive | 51.0 |
| | | wax | material | |
| | Poval, Kuraray Co. | Polyvinyl alcohol, | Binder | 8.3 |
| | | highly saponified, | | |
| | | high viscosity | | |
| | n.a. | n.a. | Rheology additives | Balance |
| Protective | Poval, Kuraray Co. | Polyvinyl alcohol, | Binder | 75.0 |
| layer | | highly saponified, | | |
| 1.0 g/m² | | high viscosity | | |
| | | Silicon oxide | Inorganic pigment | 8.0 |
| | | Zinc stearate | Lubricant/release agent | 4.0 |
| | | Ammonium zirconium | Crosslinker | 11.0 |
| | | carbonate | | |
| | n.a. | n.a. | Rheology additives | Balance |

n.a.: Common materials known to those skilled in the art.

In order to improve certain coating properties, additional components, more particularly rheology additives such as thickeners and/or surfactants, are added to the individual layers. The additional components are added in such quantities that the % by weight of the respective layer adds up to 100% by weight. The corresponding quantities are familiar to those skilled in the art.

### 4. Example 4

In exemplary embodiment 4, the color layer and the heat-sensitive layer are applied consecutively by a single and/or simultaneously by a double curtain coater to the paper substrate at a speed of 900 m/min on a paper coating machine. Each application is followed in a conventional manner by the drying process of the respective coated paper substrate.

TABLE 4
Composition of the individual layers of the heat-sensitive
recording material according to example 4.
Example 4 (FIG. 3)

| | Formulation | Formulation | | |
|---|---|---|---|---|
| Layer | ingredient | ingredient | | Quantity |
| basis weight | Trade name | Chemical name | Function | % by wt.] |
| Color layer | Ropaque HP-1055, | Styrene-acrylate | Polymer particles | 47.2 |
| 7.5 g/m² | Dow Co. | copolymer | | |
| | | Kaolin | Inorganic pigment | 16.2 |
| | Latex, Styron Co. | Styrene-butadiene | Binder | 12.8 |
| | | latex | | |
| | | Dye | Dye/color pigment | 23.3 |
| | n.a. | n.a. | Rheology additives | Balance |
| Heat-sensitive | Plastic Pigment | Styrene polymer | Polymer particles | 35.3 |
| layer | 756A, Trinseo LLC | | | |
| 4.0 g/m² | Chukyo Co. | Stearic acid | Heat-sensitive | 30.8 |
| | | amide wax | material | |
| | Latex, Styron Co. | Styrene-butadiene | Binder | 10.3 |
| | | latex | | |
| | | Zinc stearate | Lubricant/release | 3.5 |
| | | | agent | |
| | | Precipitated calcium | Inorganic pigment | 6.0 |
| | | carbonate, calcite type | | |
| | | Silicon oxide | Inorganic pigment | 9.0 |
| | n.a. | n.a. | Rheology additives | Balance |

n.a.: Common materials known to those skilled in the art.

In order to improve certain coating properties, additional components, more particularly rheology additives such as thickeners and/or surfactants, are added to the individual layers. The additional components are added in such quantities that the % by weight of the respective layer adds up to 100% by weight. The corresponding quantities are familiar to those skilled in the art.

### 5. Example 5

In exemplary embodiment 5, the color layer and the heat-sensitive layer are applied consecutively by a single and/or simultaneously by a double curtain coater to the paper substrate at a speed of 900 m/min on a paper coating machine. Each application is followed in a conventional manner by the drying process of the respective coated paper substrate.

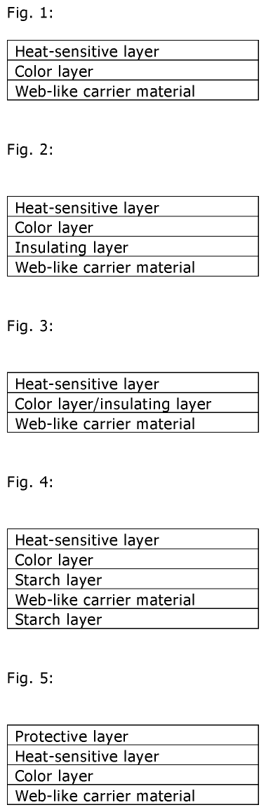

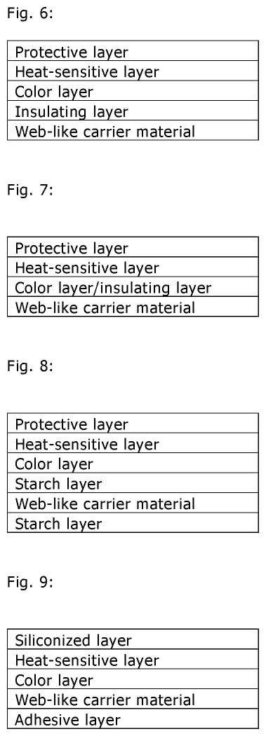

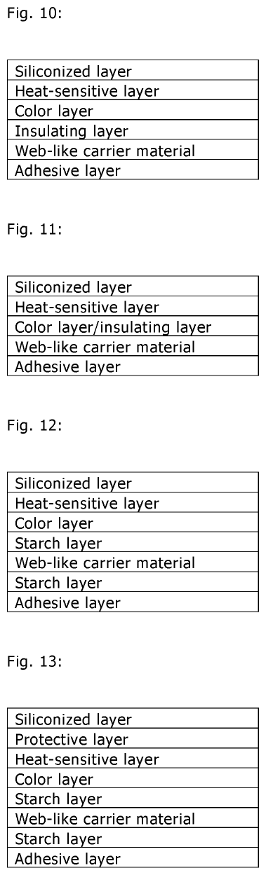

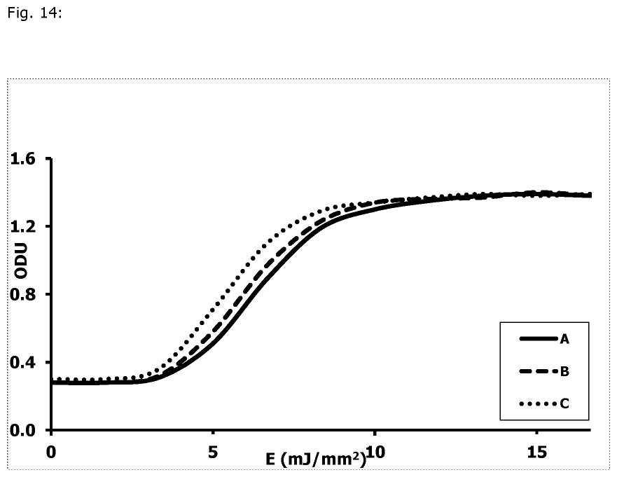

TABLE 5
Composition of the individual layers of the heat-sensitive
recording material according to example 5.
Example 5 (FIG. 1)

| | Formulation | Formulation | | |
|---|---|---|---|---|
| Layer | ingredient | ingredient | | Quantity |
| basis weight | Trade name | Chemical name | Function | % by wt.] |
| Color layer | | Precipitated calcium | Inorganic pigment | 40.3 |
| 4.0 g/m² | | carbonate, calcite type | | |
| | Latex, Styron Co. | Styrene-butadiene | Binder | 16.9 |
| | | latex | | |
| | | Dye | Dye/color pigment | 42.4 |
| | n.a. | n.a. | Rheology additives | Balance |
| Heat-sensitive | Chukyo Co. | Stearic acid | Heat-sensitive | 72.3 |
| layer | | amide wax | material/lubricant | |
| 6.0 g/m² | Poval, Kuraray Co. | Polyvinyl alcohol, | Binder | 12.8 |
| | | highly saponified, | | |
| | | high viscosity | | |
| | | Precipitated calcium | Inorganic pigment | 5.5 |
| | | carbonate, calcite type | | |
| | | Silicon oxide | Inorganic pigment | 8.7 |
| | n.a. | n.a. | Rheology additives | Balance |

n.a.: Common aids known to those skilled in the art.

In order to improve certain coating properties, additional components, more particularly rheology additives such as thickeners and/or surfactants, are added to the individual layers. The additional components are added in such quantities that the % by weight of the respective layer adds up to 100% by weight. The corresponding quantities are familiar to those skilled in the art.

### 6. Example 6

In exemplary embodiment 6, the insulating layer is applied to the paper substrate on a paper machine using a film press at a speed of 800 m/min. The color layer and the heat-sensitive layer are applied consecutively by a single and/or simultaneously by a double curtain coater at a speed of 900 m/min to the paper substrate provided with an insulating layer on a paper coating machine. Each application is followed in a conventional manner by the drying process of the respective coated paper substrate.

TABLE 6
Composition of the individual layers of the heat-sensitive
recording material according to the example.
Example 6 (FIG. 2)

| | Formulation | Formulation | | |
|---|---|---|---|---|
| Layer | ingredient | ingredient | | Quantity |
| basis weight | Trade name | Chemical name | Function | % by wt.] |
| Insulating | Ropaque HP-1055, | Styrene-acrylate | Polymer particles | 41.1 |
| layer 2.5- | Dow Co. | copolymer | | |
| 3.0 g/m² | | Precipitated calcium | Inorganic pigment | 39.9 |
| | | carbonate, calcite type | | |
| | Poval, Kuraray Co. | Polyvinyl alcohol, | Binder | 3.0 |
| | | highly saponified, | | |
| | | low viscosity | | |
| | Latex, Styron Co. | Styrene-butadiene | Binder | 15.5 |
| | | latex | | |
| | n.a. | n.a. | Rheology additives | Balance |
| Color layer | | Kaolin | Inorganic pigment | 67.4 |
| 3.5 g/m² | | | | |
| | Poval, Kuraray Co. | Polyvinyl alcohol, | Binder | 20.0 |
| | | highly saponified, | | |
| | | low viscosity | | |
| | | Dye | Dye/color pigment | 12.0 |
| | n.a. | n.a. | Rheology additives | Balance |
| Heat-sensitive | Ropaque OP-96, | Styrene-acrylate | Polymer particles | 44.1 |
| layer | Dow Co. | copolymer | | |
| 3.5 g/m² | | Sodium metaborate | Crosslinker | 0.9 |
| | | tetrahydrate | | |
| | Chukyo Co. | Stearic acid | Heat-sensitive | 34.4 |
| | | amide wax | material | |
| | | Silicon oxide | Inorganic pigment | 8.0 |
| | | Zinc stearate | Lubricant/release | 3.9 |
| | | | agent | |
| | Poval, Kuraray Co. | Polyvinyl alcohol, | Binder | 8.3 |
| | | highly saponified, | | |
| | | high viscosity | | |
| | n.a. | n.a. | Rheology additives | Balance |

n.a.: Common materials known to those skilled in the art.

In order to improve certain coating properties, additional components, more particularly rheology additives such as thickeners and/or surfactants, are added to the individual layers. The additional components are added in such quantities that the % by weight of the respective layer adds up to 100% by weight. The corresponding quantities are familiar to those skilled in the art.

It has been shown that using any mixture of scattering particles/polymer particles (e.g., styrene-acrylate copolymer) and inorganic pigment (e.g., calcined kaolin) in the insulating/color layer offers particular advantages in terms of improved barcode readability of the heat-sensitive recording material due to a high degree of fixation of the heat-sensitive layer on the color layer.

The mixing ratio between scattering particles/polymer particles and inorganic pigment is preferably in the range from 8:1 to 1:8, particularly preferably in the range from 4:1 to 1:4, based on the quantities [% by wt.] in the oven-dry state (ods).

The following examples (examples 7 to 12) explain these embodiments in more detail without limiting their scope.

### 7. Example 7

In exemplary embodiment 7, the color layer and the heat-sensitive layer are applied consecutively by a single and/or simultaneously by a double curtain coater to the paper substrate at a speed of 900 m/min on a paper coating machine. After each application, the drying process of the respective coated paper carrier is carried out in the usual manner without negatively affecting the properties of the heat-sensitive recording material according to the invention, such as the surface whiteness or paper whiteness of the heat-sensitive layer.

TABLE 7
Composition of the individual layers of the heat-sensitive recording material according to example 7.
Example 7 (FIG. 3)

| | Formulation | Formulation | | Quant [symbol] ty |
|---|---|---|---|---|
| Layer | ingredient | ingredient | | [symbol] % by |
| basis weight | Trade name | Chemical name | Function | [symbol] t.] |
| Color layer | Ropaque HP-1055, | Styrene-acrylate | Scattering particles/polymer | 36.3 |
| 5.2 g/m² | Dow Co. | copolymer | particles | |
| | | Calcined kaolin | Inorganic pigment | 16.0 |
| | Latex, Styron Co. | Styrene-butadiene | Binder | 25.7 |
| | | latex | | |
| | | Carbon black | Dye/color pigment | 21.2 |
| | n.a. | n.a. | Rheology additives | Balance |
| Heat-sensitive | Ropaque OP-96, | Styrene-acrylate | Scattering particles/polymer | 35.1 |
| layer | Dow Co. | copolymer | particles | |
| 3.5 g/m² | | Sodium metaborate | Crosslinker | 0.7 |
| | | tetrahydrate | | |
| | Chukyo Co. | Stearic acid amide | Heat-sensitive material | 40.4 |
| | | wax | | |
| | | Silicon oxide | Inorganic pigment | 9.0 |
| | | Zinc stearate | Lubricant/release agent | 3.2 |
| | Poval, Kuraray Co. | Polyvinyl alcohol, | Binder | 8.3 |
| | | highly saponified, | | |
| | | high viscosity | | |
| | n.a. | n.a. | Rheology additives | Balance |

n.a.: Common materials known to those skilled in the art. [symbol]
indicates data missing or illegible when filed

In order to improve certain coating properties, additional components, more particularly rheology additives such as thickeners and/or surfactants, are added to the individual layers. The additional components are added in such quantities that the % by weight of the respective layer adds up to 100% by weight. The corresponding quantities are familiar to those skilled in the art.

### 8. Example 8

In exemplary embodiment 8, the color layer and the heat-sensitive layer are applied consecutively by a single and/or simultaneously by a double curtain coater to the paper substrate at a speed of 900 m/min on a paper coating machine. After each application, the drying process of the respective coated paper carrier is carried out in the usual manner without negatively affecting the properties of the heat-sensitive recording material according to the invention, such as the surface whiteness or paper whiteness of the heat-sensitive layer.

TABLE 8
Composition of the individual layers of the heat-sensitive recording
material according to example 8.
Example 8 (FIG. 4)

| | Formulation | Formulation | | Quantity |
|---|---|---|---|---|
| Layer | ingredient | ingredient | | [symbol] % by |
| basis weight | Trade name | Chemical name | Function | [symbol] t.] |
| Color layer | Ropaque HP-1055, | Styrene-acrylate | Scattering | 16.0 |
| 7.0 g/m² | Dow Co. | copolymer | particles/polymer | |
| | | | particles | |
| | | Calcined kaolin | Inorganic pigment | 42.2 |
| | | Precipitated calcium | Inorganic pigment | 22.9 |
| | | carbonate, calcite | | |
| | | type | | |
| | Latex, Styron Co. | Styrene-butadiene | Binder | 8.6 |
| | | latex | | |
| | | Carbon black | Dye/color pigment | 19.0 |
| | n.a. | n.a. | Rheology additives | Balance |
| Heat-sensitive | Ropaque OP-96, | Styrene-acrylate | Scattering particles, | 36.1 |
| layer | Dow Co. | copolymer | polymer particles | |
| 3.5 g/m² | | Sodium metaborate | Crosslinker | 0.5 |
| | | tetrahydrate | | |
| | Chukyo Co. | Stearic acid amide | Heat-sensitive | 40.4 |
| | | wax | material | |
| | | Silicon oxide | Inorganic pigment | 8.0 |
| | | Zinc stearate | Lubricant/release | 3.9 |
| | | | agent | |
| | Poval, Kuraray Co. | Polyvinyl alcohol, | Binder | 10.3 |
| | | highly saponified, | | |
| | | high viscosity | | |
| | n.a. | n.a. | Rheology additives | Balance |

n.a.: Common materials known to those skilled in the art. [symbol]
indicates data missing or illegible when filed

In order to improve certain coating properties, additional components, more particularly rheology additives such as thickeners and/or surfactants, are added to the individual layers. The additional components are added in such quantities that the % by weight of the respective layer adds up to 100% by weight. The corresponding quantities are familiar to those skilled in the art.

### 9. Example 9

In exemplary embodiment 9, the color layer and the heat-sensitive layer are applied consecutively by a single and/or simultaneously by a double curtain coater to the paper substrate at a speed of 900 m/min on a paper coating machine. After each application, the drying process of the respective coated paper carrier is carried out in the usual manner without negatively affecting the properties of the heat-sensitive recording material according to the invention, such as the surface whiteness or paper whiteness of the heat-sensitive layer.

TABLE 9
Composition of the individual layers of the heat-sensitive recording
material according to example 9.
Example 9 (FIG. 8)

| | Formulation | Formulation | | Quantity |
|---|---|---|---|---|
| Layer | ingredient | ingredient | | [symbol] % by |
| basis weight | Trade name | Chemical name | Function | [symbol] t.] |
| Color layer | Ropaque HP-1055, | Styrene-acrylate | Scattering | 17.2 |
| 7.0 g/m² | Dow Co. | copolymer | particles/polymer | |
| | | | particles | |
| | | Calcined kaolin | Inorganic pigment | 35.0 |
| | | Precipitated calcium | Inorganic pigment | 16.9 |
| | | carbonate, calcite | | |
| | | type | | |
| | Latex, Styron Co. | Styrene-butadiene | Binder | 12.6 |
| | | latex | | |
| | | Carbon black | Dye/Color pigment | 19.0 |
| | n.a. | n.a. | Rheology additives | Balance |
| Heat-sensitive | Ropaque OP-96, | Styrene-acrylate | Scattering particles, | 38.5 |
| layer | Dow Co. | copolymer | polymer particles | |
| 3.5 g/m² | | Ammonium zirconium | Crosslinker | 0.9 |
| | | carbonate | | |
| | Chukyo Co. | Stearic acid amide | Heat-sensitive material | 51.0 |
| | | wax | | |
| | Poval, Kuraray Co. | Polyvinyl alcohol, | Binder | 8.3 |
| | | highly saponified, | | |
| | | high viscosity | | |
| | n.a. | n.a. | Rheology additives | Balance |
| Protective layer | Poval, Kuraray Co. | Polyvinyl alcohol, | Binder | 75.0 |
| 1.0 g/m² | | highly saponified, | | |
| | | high viscosity | | |
| | | Silicon oxide | Inorganic pigment | 8.0 |
| | | Zinc stearate | Lubricant/release agent | 4.0 |
| | | Ammonium zirconium | Crosslinker | 11.0 |
| | | carbonate | | |
| | n.a. | n.a. | Rheology additives | Balance |

n.a.: Common materials known to those skilled in the art. [symbol]
indicates data missing or illegible when filed

In order to improve certain coating properties, additional components, more particularly rheology additives such as thickeners and/or surfactants, are added to the individual layers. The additional components are added in such quantities that the % by weight of the respective layer adds up to 100% by weight. The corresponding quantities are familiar to those skilled in the art.

### 10. Example 10

In exemplary embodiment 10, the color layer and the heat-sensitive layer are applied consecutively by a single and/or simultaneously by a double curtain coater to the paper substrate at a speed of 900 m/min on a paper coating machine. After each application, the drying process of the respective coated paper carrier is carried out in the usual manner without negatively affecting the properties of the heat-sensitive recording material according to the invention, such as the surface whiteness or paper whiteness of the heat-sensitive layer.

TABLE 10
Composition of the individual layers of the heat-sensitive recording
material according to example 10.
Example 10 (FIG. 3)

| | Formulation | Formulation | | Quantity |
|---|---|---|---|---|
| Layer | ingredient | ingredient | | [symbol] % by |
| basis weight | Trade name | Chemical name | Function | [symbol] t.] |
| Color layer | Ropaque HP-1055, | Styrene-acrylate | Scattering | 32.2 |
| 7.5 g/m² | Dow Co. | copolymer | particles/polymer | |
| | | | particles | |
| | | Calcined kaolin | Inorganic pigment | 15.0 |
| | | Kaolin | Inorganic pigment | 16.2 |
| | Latex, Styron Co. | Styrene-butadiene | Binder | 12.8 |
| | | latex | | |
| | | Carbon black | Dye/color pigment | 23.3 |
| | n.a. | n.a. | Rheology additives | Balance |
| Heat-sensitive | Plastic Pigment | Styrene polymer | Scattering | 35.3 |
| layer | 756A, Trinseo LLC | | particles/polymer | |
| 4.0 g/m² | | | particles | |
| | Chukyo Co. | Stearic acid | Heat-sensitive material | 30.8 |
| | | amide wax | | |
| | Latex, Styron Co. | Styrene-butadiene | Binder | 10.3 |
| | | latex | | |
| | | Zinc stearate | Lubricant/release agent | 3.5 |
| | | Precipitated | Inorganic pigment | 6.0 |
| | | calcium | | |
| | | carbonate, calcite | | |
| | | type | | |
| | | Silicon oxide | Inorganic pigment | 9.0 |
| | n.a. | n.a. | Rheology additives | Balance |

n.a.: Common materials known to those skilled in the art. [symbol]
indicates data missing or illegible when filed

In order to improve certain coating properties, additional components, more particularly rheology additives such as thickeners and/or surfactants, are added to the individual layers. The additional components are added in such quantities that the % by weight of the respective layer adds up to 100% by weight. The corresponding quantities are familiar to those skilled in the art.

### 11. Example 11

In exemplary embodiment 11, the color layer and the heat-sensitive layer are applied consecutively by a single and/or simultaneously by a double curtain coater to the paper substrate at a speed of 900 m/min on a paper coating machine. After each application, the drying process of the respective coated paper carrier is carried out in the usual manner without negatively affecting the properties of the heat-sensitive recording material according to the invention, such as the surface whiteness or paper whiteness of the heat-sensitive layer.

TABLE 11
Composition of the individual layers of the heat-sensitive recording material according to example 11.
Example 11 (FIG. 1)

| | Formulation | Formulation | | Quantity |
|---|---|---|---|---|
| Layer | ingredient | ingredient | | [symbol] % by |
| basis weight | Trade name | Chemical name | Function | [symbol] t.] |
| Color layer | Ropaque HP-1055, | Styrene-acrylate | Scattering particles/polymer | 15.3 |
| 4.0 g/m² | Dow Co. | copolymer | particles | |
| | | Calcined kaolin | Inorganic pigment | 14.7 |
| | | Precipitated | Inorganic pigment | 28.3 |
| | | calcium carbonate, | | |
| | | calcite type | | |
| | Latex, Styron Co. | Styrene-butadiene | Binder | 8.9 |
| | | latex | | |
| | | Carbon black | Dye/color pigment | 32.4 |
| | n.a. | n.a. | Rheology additives | Balance |
| Heat-sensitive | Chukyo Co. | Stearic acid amide | Scattering particles/heat- | 72.3 |
| layer | | wax | sensitive material/lubricant | |
| 6.0 g/m² | Poval, Kuraray Co. | Polyvinyl alcohol, | Binder | 12.8 |
| | | highly saponified, | | |
| | | high viscosity | | |
| | | Precipitated | Inorganic pigment | 5.5 |
| | | calcium carbonate, | | |
| | | calcite type | | |
| | | Silicon oxide | Inorganic pigment | 8.7 |
| | n.a. | n.a. | Rheology additives | Balance |

n.a.: Common aids known to those skilled in the art. [symbol]
indicates data missing or illegible when filed

In order to improve certain coating properties, additional components, more particularly rheology additives such as thickeners and/or surfactants, are added to the individual layers. The additional components are added in such quantities that the % by weight of the respective layer adds up to 100% by weight. The corresponding quanitites are familiar to those skilled in the art.

### 12. Example 12

In exemplary embodiment example 12, the insulating layer is applied to the paper substrate on a paper machine using a film press at a speed of 800 m/min. The color layer and the heat-sensitive layer are applied consecutively by a single and/or simultaneously by a double curtain coater at a speed of 900 m/min to the paper substrate provided with an insulating layer on a paper coating machine. After each application, the drying process of the respective coated paper carrier is carried out in the usual manner without negatively affecting the properties of the heat-sensitive recording material according to the invention, such as the surface whiteness or paper whiteness of the heat-sensitive layer.

TABLE 12
Composition of the individual layers of the heat-sensitive recording material according to example 12.
Example 12 (FIG. 2)

| | Formulation | | | Quantity |
|---|---|---|---|---|
| Layer | ingredient | Formulation ingredient | | [symbol] % by |
| basis weight | Trade name | Chemical name | Function | [symbol] t.] |
| Insulating layer | Ropaque HP- | Styrene-acrylate | Scattering particles/polymer | 41.1 |
| 2.5-3.0 g/m² | 1055, Dow Co. | copolymer | particles | |
| | | Calcined kaolin | Inorganic pigment | 12.3 |
| | | Precipitated calcium | Inorganic pigment | 25.6 |
| | | carbonate, calcite type | | |
| | Poval, Kuraray | Polyvinyl alcohol, | Binder | 3.0 |
| | Co. | highly saponified, low | | |
| | | viscosity | | |
| | | Ammonium zirconium | Crosslinker | 2.0 |
| | | carbonate | | |
| | Latex, Styron | Styrene-butadiene | Binder | 15.5 |
| | Co. | latex | | |
| | n.a. | n.a. | Rheology additives | Balance |
| Color layer | | Kaolin | Inorganic pigment | 61.2 |
| 3.5 g/m² | Poval, Kuraray | Polyvinyl alcohol, | Binder | 20.0 |
| | Co. | highly saponified, low | | |
| | | viscosity | | |
| | | Ammonium zirconium | Crosslinker | 6.2 |
| | | carbonate | | |
| | | Carbon black | Dye/color pigment | 12.0 |
| | n.a. | n.a. | Rheology additives | Balance |
| Heat-sensitive | Ropaque OP-96, | Styrene-acrylate | Scattering particles/polymer | 44.1 |
| layer | Dow Co. | copolymer | particles | |
| 3.5 g/m² | | Sodium metaborate | Crosslinker | 0.9 |
| | | tetrahydrate | | |
| | Chukyo Co. | Stearic acid amide wax | Heat-sensitive material | 34.4 |
| | | Silicon oxide | Inorganic pigment | 8.0 |
| | | Zinc stearate | Lubricant/release agent | 3.9 |
| | Poval, Kuraray | Polyvinyl alcohol, | Binder | 8.3 |
| | Co. | highly saponified, high | | |
| | | viscosity | | |
| | n.a. | n.a. | Rheology additives | Balance |

n.a.: Common materials known to those skilled in the art. [symbol]
indicates data missing or illegible when filed

In order to improve certain coating properties, additional components, more particularly rheology additives such as thickeners and/or surfactants, are added to the individual layers. The additional components are added in such quantities that the % by weight of the respective layer adds up to 100% by weight. The corresponding quantities are familiar to those skilled in the art.

TABLE 13

| | Comparative example | E1 | E2 | E3 |
|---|---|---|---|---|
| Dye | Carbon black [2.1% by | Carbon black [1.1% by | Carbon black/ | Substantive dye* |
| | weight, based on | weight, based on | binder crosslinker | |
| | recording material] | recording material] | concept B/K* | |
| Dye class | Carbon | Carbon | | |
| Final blackening (optical | 1.40 | 1.31 | 1.37 | 1.45 |
| density) | | | | |
| a) Luminosity Y (maximum of | 30 | 30 | max. 35 | max. 35 |
| 35 points) | | | | |
| b) Color coefficient a* in the | 20 | 20 | max. 20 | max. 20 |
| CIELAB system (maximum of | | | | |
| 20 points) | | | | |
| c) Dirt specks A in size | −15 | 1 | max. 15 | max. 15 |
| classes A50 (maximum of 15 | | | | |
| points) | | | | |
| d) Dirt specks A in size | −10 | 20 | max. 10 | max. 10 |
| classes and A250 (maximum | | | | |
| of 10 points) | | | | |
| e) Degree of dye elimination | 10 | 10 | max. 10 | max. 10 |
| (ink elimination) IE | | | | |
| (maximum of 10 points) | | | | |
| f) Filtrate darkening ΔY | −10 | 0 | max. 10 | max. 10 |
| (maximum of 10 points) | | | | |
| Sum of points (score; | 25 | 54 | max. 100 | max. 100 |
| maximum of 100 points) | | | | |
| Assessment | Not suitable for deinking | Suitable for deinking, | Suitable for deinking, | Suitable for deinking, |
| | without the addition of | more particularly for | more particularly for | more particularly for |
| | waste paper or wood-free, | recycling according to | recycling according to | recycling according to |
| | uncoated copy paper | the recyclability | the recyclability | the recyclability |
| | | criteria¹ | criteria¹ | criteria¹ |
| Remark | | | *(Meth)acrylamide-acrylate | *Pergasol Black 18 LNA |
| | | | copolymer of the core-shell | |
| | | | type | |

¹Criteria for recyclability:
a) In an initial mixture consisting of 100% wood-free, uncoated copy paper with a dry toner printed on both sides and a coverage of 5% (CEN_TEST Master from EN 12281) per side, the addition of 1% heat-sensitive recording material only worsens the light reflectance value after flotation by a maximum of 6 points and the filtrate darkening by a maximum of 3 points compared to the floated initial mixture without heat-sensitive recording material; and/or
b) in an initial waste paper mixture of newspapers/magazines (offset, uncoated) in a ratio of 60%/40%, the addition of 5% heat-sensitive recording material only worsens the light reflectance value after flotation by a maximum of 6 points and the filtrate darkening by a maximum of 3 points compared to the floated initial mixture without heat-sensitive recording material.

TABLE 14

| | E4 | E5 | E6 | E7 |
|---|---|---|---|---|
| Dye | Carbon black/ | Carbon black/ | Waterflexo/Aqualabel* | Graphite |
| | Binder concept W* | Binder concept (SK on 1/0- | | |
| | | HK)* | | |
| Dye class | | | | Carbon |
| Final blackening (optical | 1.44 | 1.49 | 1.45 | 0.66 |
| density) | | | | |
| a) Luminosity Y (maximum of | max. 35 | max. 35 | max. 35 | max. 35 |
| 35 points) | | | | |
| b) Color coefficient a* in the | max. 20 | max. 20 | max. 20 | max. 20 |
| CIELAB system (maximum of | | | | |
| 20 points) | | | | |
| c) Dirt specks A in size classes | max. 15 | max. 15 | max. 15 | max. 15 |
| A50 (maximum of 15 points) | | | | |
| d) Dirt specks A in size classes | max. 10 | max. 10 | max. 10 | max. 10 |
| and A250 (maximum of | | | | |
| 10 points) | | | | |
| e) Degree of dye elimination | max. 10 | max. 10 | max. 10 | max. 10 |
| (ink elimination) IE (maximum | | | | |
| of 10 points) | | | | |
| f) Filtrate darkening ΔY | max. 10 | max. 10 | max. 10 | max. 10 |
| (maximum of 10 points) | | | | |
| Sum of points (score; | max. 100 | max. 100 | max. 100 | max. 100 |
| maximum of 100 points) | | | | |
| Assessment | Suitable for deinking, | Suitable for deinking, more | Suitable for deinking, | Suitable for deinking, |
| | more particularly for | particularly for recycling | more particularly for | more particularly for |
| | recycling according to | according to the recyclability | recycling according to the | recycling according to the |
| | the recyclability criteria¹ | criteria¹ | recyclability criteria¹ | recyclability criteria¹ |
| Remark | *Ethylene-acrylate | *Styrene-butadiene latex | *Process black HK/HR | |
| | copolymer | (double amount) and natural | | |
| | | calcium carbonate | | |

¹Criteria for recyclability:
a) In an initial mixture consisting of 100% wood-free, uncoated copy paper with a dry toner printed on both sides and a coverage of 5% (CEN_TEST Master from EN 12281) per side, the addition of 1% heat-sensitive recording material only worsens the light reflectance value after flotation by a maximum of 6 points and the filtrate darkening by a maximum of 3 points compared to the floated initial mixture without heat-sensitive recording material; and/or
b) in an initial waste paper mixture of newspapers/magazines (offset, uncoated) in a ratio of 60%/40%, the addition of 5% heat-sensitive recording material only worsens the light reflectance value after flotation by a maximum of 6 points and the filtrate darkening by a maximum of 3 points compared to the floated initial mixture without heat-sensitive recording material.

TABLE 15

| | E8 | E9 | E10 | E11 |
|---|---|---|---|---|
| Dye | Sulfur dye/cassulfon* | Iron gall ink | RYB mixture, red, yellow, | Iron oxide/Bayferrox |
| | | | blue pigment | 306/Fe₃O₄ |
| | | | 1:1:1/Pergalite pigments* | |
| Dye class | | | Inorganic and/or organic | Iron oxide/magnetic or |
| | | | pigment dyes | magnetizable |
| | | | | dyes/pigments |
| Final blackening (optical | 1.37 | 1.05 | 1.4 | 0.57 |
| density) | | | | |
| a) Luminosity Y (maximum of | max. 35 | max. 35 | max. 35 | max. 35 |
| 35 points) | | | | |
| b) Color coefficient a* in the | max. 20 | max. 20 | max. 20 | max. 20 |
| CIELAB system (maximum of | | | | |
| 20 points) | | | | |
| c) Dirt specks A in size classes | max. 15 | max. 15 | max. 15 | max. 15 |
| A50 (maximum of 15 points) | | | | |
| d) Dirt specks A in size classes | max. 10 | max. 10 | max. 10 | max. 10 |
| and A250 (maximum of | | | | |
| 10 points) | | | | |
| e) Degree of dye elimination | max. 10 | max. 10 | max. 10 | 9 |
| (ink elimination) IE (maximum | | | | |
| of 10 points) | | | | |
| f) Filtrate darkening ΔY | max. 10 | max. 10 | max. 10 | 9 |
| (maximum of 10 points) | | | | |
| Sum of points (score; | max. 100 | max. 100 | max. 100 | max. 98 |
| maximum of 100 points) | | | | |
| Assessment | Suitable for deinking, more | Suitable for deinking, more | Suitable for deinking, | Suitable for deinking, |
| | particularly for recycling | particularly for recycling | more particularly for | more particularly for |
| | according to the | according to the | recycling according to the | recycling according to the |
| | recyclability criteria¹ | recyclability criteria¹ | recyclability criteria¹ | recyclability criteria¹ |
| Remark | *Cassulfon Black PM-S | | *Pergalite Yellow G-L; | Deinking was carried out |
| | | | Red G-L; Blue R-LW | by magnetic removal of |
| | | | | the dye |

¹Criteria for recyclability:
a) In an initial mixture consisting of 100% wood-free, uncoated copy paper with a dry toner printed on both sides and a coverage of 5% (CEN_TEST Master from EN 12281) per side, the addition of 1% heat-sensitive recording material only worsens the light reflectance value after flotation by a maximum of 6 points and the filtrate darkening by a maximum of 3 points compared to the floated initial mixture without heat-sensitive recording material; and/or
b) in an initial waste paper mixture of newspapers/magazines (offset, uncoated) in a ratio of 60%/40%, the addition of 5% heat-sensitive recording material only worsens the light reflectance value after flotation by a maximum of 6 points and the filtrate darkening by a maximum of 3 points compared to the floated initial mixture without heat-sensitive recording material.

TABLE 16

| | E12 | E13 | E14 | E15 |
|---|---|---|---|---|
| Dye | Iron oxide black | Carbon black [2.1% by | Carbon black [2.1% by | Carbon black [1.1% by |
| | suspension*/Fe₃O₄ | weight, based on | weight, based on | weight, based on |
| | | recording material] | recording material] | recording material] |
| Dye class | Iron oxide/magnetic or | | | |
| | magnetizable dyes/pigments | | | |
| Final blackening (optical | 0.61 | 1.4 | 1.4 | 1.31 |
| density) | | | | |
| a) Luminosity Y (maximum of | max. 35 | 34 | 35 | 34 |
| 35 points) | | | | |
| b) Color coefficient a* in the | max. 20 | 18 | 20 | 20 |
| CIELAB system (maximum of | | | | |
| 20 points) | | | | |
| c) Dirt specks A in size | max. 15 | 10 | 12 | 15 |
| classes A50 (maximum of 15 | | | | |
| points) | | | | |
| d) Dirt specks A in size | max. 10 | 8 | 10 | 7 |
| classes and A250 (maximum | | | | |
| of 10 points) | | | | |
| e) Degree of dye elimination | 9 | 2 | 8 | 8 |
| (ink elimination) IE | | | | |
| (maximum of 10 points) | | | | |
| f) Filtrate darkening ΔY | 9 | 2 | 10 | 8 |
| (maximum of 10 points) | | | | |
| Sum of points (score; | max. 98 | 74 | 95 | 92 |
| maximum of 100 points) | | | | |
| Assessment | Suitable for deinking, more | Suitable for deinking, more | Suitable for deinking | Suitable for deinking |
| | particularly for recycling | particularly for recycling | | |
| | according to the recyclability | according to the recyclability | | |
| | criteria¹ | criteria¹ | | |
| Remark | Deinking was carried out by | Mixture of max. 3% by | Mixture of 0.1% by | Mixture of 2.5% by |
| | magnetic removal of the dye | weight comparative example | weight comparative | weight E1 and 97.5% by |
| | *Bayferrox 350 fl. | and min. 97% by weight waste | example and 99.9% by | weight waste paper |
| | | paper is suitable for deinking | weight waste paper | composition suitable for |
| | | | composition suitable for | deinking |
| | | | deinking | |

¹Criteria for recyclability:
a) In an initial mixture consisting of 100% wood-free, uncoated copy paper with a dry toner printed on both sides and a coverage of 5% (CEN_TEST Master from EN 12281) per side, the addition of 1% heat-sensitive recording material only worsens the light reflectance value after flotation by a maximum of 6 points and the filtrate darkening by a maximum of 3 points compared to the floated initial mixture without heat-sensitive recording material; and/or
b) in an initial waste paper mixture of newspapers/magazines (offset, uncoated) in a ratio of 60%/40%, the addition of 5% heat-sensitive recording material only worsens the light reflectance value after flotation by a maximum of 6 points and the filtrate darkening by a maximum of 3 points compared to the floated initial mixture without heat-sensitive recording material.

TABLE 17

| | E16 | E18 | E19 | E20 |
|---|---|---|---|---|
| Dye | Carbon black [1.1% by | Carbon black [1.1% by | RYB mixture, red, yellow, | RYB mixture, red, yellow, |
| | weight, based on | weight, based on | blue pigment | blue pigment |
| | recording material] | recording materiall | 1:1:1/Pergalite pigments | 1:1:1/Pergalite pigments |
| Dye class | | | | |
| Final blackening (optical | 1.31 | 1.31 | 1.4 | 1.4 |
| density) | | | | |
| a) Luminosity Y (maximum of | 35 | 11 | 35 | 35 |
| 35 points) | | | | |
| b) Color coefficient a* in the | 20 | 20 | 20 | 20 |
| CIELAB system (maximum of | | | | |
| 20 points) | | | | |
| c) Dirt specks A in size classes | 15 | 15 | 15 | 15 |
| A50 (maximum of 15 points) | | | | |
| d) Dirt specks A in size classes | 10 | 10 | 10 | 10 |
| and A250 (maximum of | | | | |
| 10 points) | | | | |
| e) Degree of dye elimination | 10 | 10 | 7 | 10 |
| (ink elimination) IE (maximum | | | | |
| of 10 points) | | | | |
| f) Filtrate darkening ΔY | 10 | 0 | 8 | 8 |
| (maximum of 10 points) | | | | |
| Sum of points (score; | 95 | 66 | 95 | 98 |
| maximum of 100 points) | | | | |
| Assessment | Suitable for deinking | Suitable for deinking | Suitable for deinking | Suitable for deinking |
| Remark | Mixture of 5% by weight | Mixture of 10% by weight | Mixture of 2.5% by weight | Mixture of 5% by weight |
| | E1 and 95% by weight | E1 and 90% by weight | E10 and 97.5% by weight | E10 and 95% by weight |
| | waste paper composition | waste paper composition | waste paper composition | waste paper composition |
| | suitable for deinking | suitable for deinking | suitable for deinking | suitable for deinking |

TABLE 18

| | E21 | E24 | E27 |
|---|---|---|---|
| Dye | RYB mixture, red, | Carbon black/Binder | Sulfur dye |
| | yellow, blue pigment | concept W | |
| | 1:1:1/Pergalite | | |
| | pigments | | |
| Dye class | | | |
| Final blackening (optical | 1.4 | 1.44 | 1.37 |
| density) | | | |
| a) Luminosity Y (maximum of | 35 | 32 | 35 |
| 35 points) | | | |
| b) Color coefficient a* in the | 20 | 20 | 20 |
| CIELAB system (maximum of | | | |
| 20 points) | | | |
| c) Dirt specks A in size classes | 15 | 14 | 15 |
| A50 (maximum of 15 points) | | | |
| d) Dirt specks A in size classes | 10 | 8 | 10 |
| and A250 (maximum of | | | |
| 10 points) | | | |
| e) Degree of dye elimination | 10 | 8 | 6 |
| (ink elimination) IE (maximum | | | |
| of 10 points) | | | |
| f) Filtrate darkening ΔY | 7 | 6 | 6 |
| (maximum of 10 points) | | | |
| Sum of points (score; | 97 | 88 | 92 |
| maximum of 100 points) | | | |
| Assessment | Suitable for deinking | Suitable for deinking | Suitable for deinking |
| Remark | Mixture of 10% by | Mixture of 2.5% by | Mixture of 2.5% by |
| | weight E10 and 90% by | weight E4 and 97.5% by | weight E8 and 97.5% |
| | weight waste paper | weight waste paper | by weight waste paper |
| | composition suitable for | composition suitable for | composition suitable for |
| | deinking | deinking | deinking |

| | E32 | E34 |
|---|---|---|
| Dye | Carbon black [2.1% by | Carbon black [1.1% by |
| | weight, based on | weight, based on |
| | recording material] | recording material] |
| Dye class | Cartaren Black (alt. | Cartaren Black (alt. |
| | Carbon black) | Carbon black) |
| Final blackening (optical | 1.38 | 1.31 |
| density) | | |
| a) Luminosity Y (maximum of | 22 | 29 |
| 35 points) | | |
| b) Color coefficient a* in the | 20 | 20 |
| CIELAB system (maximum of | | |
| 20 points) | | |
| c) Dirt specks A in size classes | 15 | 15 |
| A50 (maximum of 15 points) | | |
| d) Dirt specks A in size classes | 10 | 10 |
| and A250 (maximum of | | |
| 10 points) | | |
| e) Degree of dye elimination | 10 | 10 |
| (ink elimination) IE (maximum | | |
| of 10 points) | | |
| f) Filtrate darkening ΔY | 4 | 5 |
| (maximum of 10 points) | | |
| Sum of points (score; | 81 | 89 |
| maximum of 100 points) | | |
| Assessment | Suitable for deinking | Suitable for deinking |
| Remark | Mixture of 2.5% by | Mixture of 5% by weight |
| | weight comparative | of E1 with Cartaren |
| | example with Cartaren | Black instead of carbon |
| | Black instead of carbon | black or E34 and 95% |
| | black or E32 and 97.5% | by weight of waste |
| | by weight waste paper | paper composition |
| | composition suitable for | suitable for deinking |
| | deinking | |

TABLE 19

| | E36 | E37 | E38 | E39 |
|---|---|---|---|---|
| Dye | Carbon black [2.1% by | Carbon black [1.6% by | Carbon black [2.1% by | Carbon black [2.1% |
| | weight, based on | weight, based on | weight, based on | by weight, based on |
| | recording material] | recording material] | recording material] | recording material] |
| Dye class | | | | |
| Final blackening (optical | | | | |
| density) | | | | |
| a) Luminosity Y (maximum of | 35 | 35 | 35 | 35 |
| 35 points) | | | | |
| b) Color coefficient a* in the | 20 | 20 | 20 | 20 |
| CIELAB system (maximum of | | | | |
| 20 points) | | | | |
| c) Dirt specks A in size | 15 | 15 | 15 | 15 |
| classes A50 (maximum of 15 | | | | |
| points) | | | | |
| d) Dirt specks A in size | 10 | 10 | 10 | 10 |
| classes and A250 (maximum | | | | |
| of 10 points) | | | | |
| e) Degree of dye elimination | 4 | 3 | 2 | 8 |
| (ink elimination) IE | | | | |
| (maximum of 10 points) | | | | |
| f) Filtrate darkening ΔY | 10 | 10 | 10 | 10 |
| (maximum of 10 points) | | | | |
| Sum of points (score; | 94 | 93 | 92 | 98 |
| maximum of 100 points) | | | | |
| Assessment | Suitable for deinking | Suitable for deinking | Suitable for deinking | Suitable for deinking |
| Remark | Mixture of 1% by | Mixture of 1% by | Mixture of 1% by weight | Mixture of 1% by |
| | weight comparative | weight E30 and 99% by | comparative example and | weight. according to |
| | example and 99% by | weight copy paper | 99% by weight copy | embodiment 3 and |
| | weight copy paper | | paper | 99% by weight copy |
| | | | | paper |

### 7. Testing of the Recyclability of the Heat-Sensitive Recording Materials of Examples E1 to E39

Examples E1 to E39 each met at least one of the following recyclability criteria:
a) In an initial mixture consisting of 100% wood-free, uncoated copy paper with a dry toner printed on both sides and a coverage of 5% (CEN_TEST Master from EN 12281) per side, the addition of 1% heat-sensitive recording material only worsens the light reflectance value after flotation by 6 points and the filtrate darkening by 3 points compared to the floated initial mixture without heat-sensitive recording material;
and/or
b) in an initial waste paper mixture of newspapers/magazines (offset, uncoated) in a ratio of 60%/40%, the addition of 5% heat-sensitive recording material only worsens the light reflectance value after flotation by 6 points and the filtrate darkening by 3 points compared to the floated initial mixture without heat-sensitive recording material.

1. A heat-sensitive recording material comprising
a web-like carrier material,
a color layer on one side of the web-like carrier material, and
a heat-sensitive layer on the color layer such that the color layer is at least partially covered,
wherein the heat-sensitive layer is configured in such a way that it becomes translucent when exposed to localized heat, such that the underlying color layer becomes visible, characterized in that the color layer contains at least one removable dye, more particularly at least one dye which can be removed in the waste paper cycle.

2. The heat-sensitive recording material according to claim 1, characterized in that after reprocessing of the heat-sensitive recording material according to INGEDE method 11, the following scores are achieved according to the Assessment of Printed Product Recyclability, Deinkability Score:
a) Luminosity Y maximum of 35 points,
b) Color coefficient a* in the CIELAB system maximum of 20 points,
c) Dirt specks A in the two different size classes A50 maximum of 15 points and A250 maximum of 10 points,
d) Degree of dye elimination (ink elimination) IE maximum of 10 points, and
e) Filtrate darkening ΔY maximum of 10 points,
wherein the sum of all points is in the range from 0 to 100

3. The heat-sensitive recording material according to claim 1, characterized in that the at least one removable dye, more particularly removable in the waste paper cycle, is selected from the group comprising bleachable dyes, hydrophobic dyes, hydrophobizable dyes and/or magnetic dyes.

4. The heat-sensitive recording material according to claim 1, characterized in that the at least one removable dye, more particularly removable in the waste paper cycle, is selected from the group comprising
carbon black pigments,
alternative carbon black pigments, preferably with different particle sizes, morphologies, primary/secondary particle composition and/or surface chemistry,
organic dyes,
direct dyes, more particularly substantive dyes,
reactive dyes,
disperse dyes,
pigment dyes,
iron oxide,
sulfur dyes,
activated carbon as a dispersion,
metal complex dyes, such as iron gall ink (iron(III) gallate),
graphite,
mica,
combinations of carbon black pigments and dark pigments, more particularly dark pigments such as iron oxides,
bio-based/food dyes, such as sepia black, caramel coloring or based on hydrothermally treated lignin, and/or
printing inks for coloring (offset, (UV) flexo inks),
and/or mixtures thereof.

5. The heat-sensitive recording material according to claim 1, characterized in that the color layer comprises at least one binder.

6. The heat-sensitive recording material according to claim 1, characterized in that the at least one removable dye is crosslinked and/or set with the binder.

7. The heat-sensitive recording material according to claim 1, characterized in that the heat-sensitive layer comprises at least one scattering particle having a glass transition temperature of −55° C. to 130° C., a melting temperature of less than 250° C. and/or an average particle size in the range from 0.1 to 2.5 μm.

8. The heat-sensitive recording material according to claim 1, characterized in that the heat-sensitive layer comprises at least one heat-sensitive material having a melting temperature in the range from 40 to 200° C. and/or a glass transition temperature in the range from 40 to 200° C.

9. The heat-sensitive recording material according to claim 1, characterized in that the heat-sensitive recording material has a residual moisture content from 2 to 14%.

10. The heat-sensitive recording material according to claim 1, characterized in that the heat-sensitive recording material has a surface whiteness of 35 to 60%.

11. The heat-sensitive recording material according to claim 1, characterized in that each layer applied to the web-like carrier material has on its upper side a Bekk smoothness which is at least as great as or greater than that of the respective underlying layer, the upper side in each case being the side on which the web-like carrier material does not lie.

12. The heat-sensitive recording material according to claim 1, characterized in that an insulating layer is present between the web-like carrier material and the color layer, wherein the insulating layer has a Bekk smoothness of more than 50 s
or
in that the color layer is both a color layer and an insulating layer, wherein the color layer, which is also an insulating layer, has a Bekk smoothness of more than 50 s.

13. The heat-sensitive recording material according to claim 1, characterized in that the heat-sensitive recording material is recyclable and has at least one of the following recyclability criteria:
a) In an initial mixture consisting of 100% wood-free, uncoated copy paper with a dry toner printed on both sides and a coverage of 5% (CEN_TEST Master from EN 12281) per side, the addition of 1% heat-sensitive recording material only worsens the light reflectance value after flotation by a maximum of 6 points and the filtrate darkening by a maximum of 3 points compared to the floated initial mixture without heat-sensitive recording material;
and/or
b) in an initial waste paper mixture of newspapers/magazines (offset, uncoated) in a ratio of 60%/40%, the addition of 5% heat-sensitive recording material only worsens the light reflectance value after flotation by a maximum of 6 points and the filtrate darkening by a maximum of 3 points compared to the floated initial mixture without heat-sensitive recording material.

14. A process for decoloring a heat-sensitive recording material according to claim 1, with a web-like carrier material, a color layer on one side of the web-like carrier material and a heat-sensitive layer on the color layer, such that the color layer is at least partially covered,
wherein the heat-sensitive layer is configured to become translucent when exposed to localized heat such that the underlying color layer becomes visible in order to obtain a fibrous material mixture, comprising the steps of
Providing a mixture of the heat-sensitive recording material and at least one other paper type, more particularly at least one waste paper type;
Decoloring the mixture in a deinking process in order to obtain a fibrous material mixture.

15. The process according to claim 14, characterized in that it comprises the following steps:
i) Providing a mixture of the heat-sensitive recording material and at least one other paper type, wherein a specific quantity of the at least one other paper type,
ii) Working up of a sample of the mixture according to INGEDE method 11,
iii) Determining the following scores according to the Assessment of Printed Product Recyclability, Deinkability Score:
a) Luminosity Y maximum of 35 points,
b) Color coefficient a* in the CIELAB system maximum of 20 points,
c) Dirt specks A in the two different size classes A50 maximum of 15 points and A250 maximum of 10 points,
d) Degree of dye elimination (ink elimination) IE maximum of 10 points, and
e) Filtrate darkening ΔY maximum of 10 points,
wherein the sum of all points is in the range from 0 to 100,
iv) Decoloring the mixture by a deinking process, provided that the sample of the mixture has reached a predetermined number of points, in order to obtain a fibrous material mixture; or
Starting again with step i) with addition of an additional quantity of at least one paper type if the sample has not yet reached a predetermined number of points.

16. A fibrous material mixture obtainable by the process according to claim 14.

17. A process for producing a recycled paper comprising the steps of:
Decoloring a heat-sensitive recording material according to the process according to claim 14 in order to obtain a fibrous material mixture, and
Producing a recycled paper comprising the fibrous material mixture, preferably with the addition of additional primary fibrous material or secondary or waste paper fibrous material, comprising compressing and dewatering the fibrous material mixture optionally containing the additional primary fibrous material or secondary or waste paper fibrous material.

18. (canceled)

19. The heat-sensitive recording material according to claim 2, characterized in wherein no individual point is negative.

20. The heat-sensitive recording material according to claim 1, characterized in that the at least one removable dye, more particularly removable in the waste paper cycle, is selected from the group comprising:
carbon black pigments up to 19% by weight,
alternative carbon black pigments with different particle sizes, morphologies, primary/secondary particle composition and/or surface chemistry,
bleachable organic dyes,
substantive dyes,
reactive dyes,
organic and/or water insoluble disperse dyes,
disperse pigment dyes,
Fe304,
sulfur dyes,
activated carbon as a dispersion,
iron gall ink (iron(III) gallate),
graphite,
mica,
combinations of carbon black pigments and Fe304,
sepia black, caramel coloring or based on hydrothermally treated lignin,
(UV) flexo inks, and/or
mixtures thereof.

21. The heat-sensitive recording material according to claim 1, characterized in that:
the at least one removable dye is removable in the waste paper cycle and is crosslinked and/or set with the binder;
the heat-sensitive layer comprises at least one polymer particle having a glass transition temperature of −55° C. to 130° C., a melting temperature of less than 250° C. and/or an average particle size in the range from 0.1 to 2.5 μm;
the heat-sensitive layer comprises a fatty acid and/or a fatty acid amide having a melting temperature in the range from 40 to 200° C. and/or a glass transition temperature in the range from 40 to 200° C.;
the heat-sensitive recording material has a residual moisture content from 3 to 18%; and
an insulating layer having a Bekk smoothness of more than 100 s is present between the web-like carrier material and the color layer
or
the color layer has a Bekk smoothness of more than 100 s and is both a color layer and an insulating layer.
